(19) United States
(12) Patent Application Publication
(10) Pub. No.: US 2024/0015520 A1
(43) Pub. Date: Jan. 11, 2024

(54) ENHANCED NETWORK AVAILABILITY FOR PRIVATE ENTERPRISE NETWORKS IN SHARED SPECTRUM SYSTEMS

(71) Applicant: Nokia Solutions and Networks Oy, Espoo (FI)

(72) Inventors: Mohammad Riaz Khawer, Wayland, MA (US); Milind M. Buddhikot, Bridgewater, NJ (US)

(21) Appl. No.: 18/365,002

(22) Filed: Aug. 3, 2023

Related U.S. Application Data
(63) Continuation-in-part of application No. 17/596,759, filed on Dec. 17, 2021.

(51) Int. Cl. H04W 16/14

(52) U.S. Cl. CPC H04W 16/14

(57) ABSTRACT

Various example embodiments relate to support for Citizens Broadband Radio Service (CBRS) Devices (CBSDs) in private enterprise networks based on a spectrum access system (SAS). Various example embodiments may support use of local SASs for handling access by CBSDs to the CBRS based on association of the local SASs with a regional SAS and support for data synchronization between the regional SAS and the local SASs associated with the regional SAS. Various example embodiments may support dynamic control of CBSD traffic for a set of SASs that includes multiple regional SASs and a local SAS. Various example embodiments may support a domain proxy local co-existence management policy capability configured to support control over CBRS channel assignments for CBSDs of a private enterprise network. Various example embodiments may be configured to utilize a domain proxy to support CBSDs in private enterprise networks based on SAS systems.

### CROSS-REFERENCE TO RELATED APPLICATIONS

This application is a continuation-in-part of U.S. patent application Ser. No. 17/596,759, filed on Dec. 17, 2021, and titled ENHANCED NETWORK AVAILABILITY FOR PRIVATE ENTERPRISE NETWORKS IN SHARED SPECTRUM SYSTEMS, which is a 371 U.S. National Phase Application of International Application No. PCT/US2019/037745, filed on Jun. 18, 2019, and titled ENHANCED NETWORK AVAILABILITY FOR PRIVATE ENTERPRISE NETWORKS IN SHARED SPECTRUM SYSTEMS, each of which is incorporated by reference herein in its entirety.

### BACKGROUND

Spectrum is the most precious commodity in deploying wireless networks such as a private enterprise network. Cellular communication systems, such as networks that provide wireless connectivity using Long Term Evolution (LTE) or Fifth Generation (5G) standards, provide more reliable service and superior quality-of-service (QoS) than comparable services provided by conventional contention-based services in unlicensed frequency bands, such as Wi-Fi. The most valuable spectrum available for cellular communication is at frequencies below 6 Gigahertz (GHz) because transmissions at these frequencies do not require a clear line of sight between the transmitter and the receiver. Much of the sub-6-GHz spectrum is already auctioned off as statically licensed spectrum to various mobile network operators (MNOs) that implement cellular communication system such as LTE networks. The 3.1-4.2 GHz spectrum is occupied by incumbents such as Fixed Satellite System (FSS) and federal incumbents such as U.S. government or military entities. For example, the 3550-3700 MHz frequency band (CBRS band) was previously reserved for exclusive use by incumbents including the United States Navy and Fixed Satellite Service (FSS) earth stations. This band of the spectrum is often highly underutilized. Consequently, organizations and vertical industries such as package distribution companies, energy producers, ports, mines, hospitals, and universities do not have access to sub-6-GHz spectrum and are therefore unable to establish private enterprise networks to provide cellular service such as LTE.

### SUMMARY OF EMBODIMENTS

The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later. In some embodiments, an apparatus is provided. The apparatus includes a processor configured to aggregate traffic for Citizens Broadband radio Service Devices (CBSDs) in a private enterprise network. The apparatus also includes a transceiver configured to monitor communication with geo-redundant instances of a spectrum access system (SAS) that allocate frequency bands in a shared spectrum to the CBSDs. The processor is configured to instantiate a local SAS in response to the geo-redundant instances of the SAS becoming unavailable and the local SAS is configured to respond to heartbeat messages from the CBSDs.

In some embodiments, the local SAS is configured to provide information indicating valid channels in response to spectrum inquiry messages received from the CBSDs and approve grant requests from the CBSDs for channels in a valid channel set.

In some embodiments, the local SAS is configured to attempt to establish a connection with an environmental sensing capability (ESC) in response to the geo-redundant SASs becoming unavailable.

In some embodiments, the local SAS determines whether the connection with the ESC has been established and whether a first geographic area and a first channel in the shared spectrum served by the CBSDs overlaps with a dynamic protection area (DPA) defined by a second geographic area and a portion of the shared spectrum allocated to an incumbent.

In some embodiments, the local SAS is configured to instruct the CBSDs to switch to a second channel if the connection was not established with the ESC and if the first geographic area and the first channel overlap with the DPA.

In some embodiments, the second channel is computed by at least one of the geo-redundant instances of the SAS based on presence information for the CBSDs and other CBSDs that are managed by other SAS vendors proximate the first geographic area.

In some embodiments, the second channel is spatially separated from the first channel by a frequency determined based on properties of the incumbent.

In some embodiments, the local SAS transmits a heartbeat response to the CBSDs that de-authorizes a grant of the first channel in response to determining that the connection with the ESC was established and in response to the ESC reporting presence of the incumbent on the first channel.

In some embodiments, the local SAS grants the CBSDs access to a second channel in response to receiving a message indicating the second channel following transmission of the heartbeat message that de-authorizes the grant of the first channel. In some embodiments, the local SAS grants the CBSDs access to the second channel in response to the second channel being previously provided to the local SAS by at least one of the geo-redundant instances of the SAS.

In some embodiments, the local SAS is configured to respond to the heartbeat messages from the CBSDs for a time interval that is determined based on a predetermined time interval for exchanging status information between peer instances of the SAS.

In some embodiments, the geo-redundant instances of the SAS determine channel and power assignments for the CBSDs based on the status information and the channel and power assignments are valid for the predetermined time interval.

In some embodiments, the local SAS receives the status information from at least one of the geo-redundant instances of the SAS, and the local SAS receives information indicating the second channel and login credentials for the ESC.

In some embodiments, a method is provided. The method includes aggregating, at a domain proxy, traffic for Citizens Broadband radio Service Devices (CBSDs) in a private enterprise network. The method also includes monitoring, at the domain proxy, communication with geo-redundant instances of a spectrum access system (SAS) that allocate frequency bands in a shared spectrum to the CBSDs. The method also includes instantiating, at the domain proxy, a local SAS in response to the geo-redundant instances of the SAS becoming unavailable. The method further includes responding, from the local SAS, to heartbeat messages from the CBSDs.

In some embodiments, responding to the heartbeat messages includes providing information indicating valid channels in response to spectrum inquiry messages received from the CBSDs.

In some embodiments, responding to the heartbeat messages includes approving grant requests from the CBSDs for channels in a valid channel set.

Some embodiments of the method include attempting to establish a connection between the local SAS and an environmental sensing capability (ESC) in response to the geo-redundant SASs becoming unavailable.

Some embodiments of the method include determining, at the local SAS, whether the connection with the ESC has been established and whether a first geographic area and a first channel in the shared spectrum served by the CBSDs overlaps with a dynamic protection area (DPA) defined by a second geographic area and a portion of the shared spectrum allocated to an incumbent.

Some embodiments of the method include instructing, at the local SAS, the CBSDs to switch to a second channel if the connection was not established with the ESC and if the first geographic area and the first channel overlap with the DPA.

In some embodiments, the second channel is computed by at least one of the geo-redundant instances of the SAS based on presence information for the CBSDs and other CBSDs that are managed by other SAS vendors proximate the first geographic area.

In some embodiments, the second channel is spatially separated from the first channel by a frequency determined based on properties of the incumbent.

Some embodiments of the method include transmitting, from the local SAS, a heartbeat response to the CBSDs that de-authorizes a grant of the first channel in response to determining that the connection with the ESC was established and in response to the ESC reporting presence of an incumbent on the first channel.

Some embodiments of the method include granting, at the local SAS, the CBSDs access to a second channel in response to receiving a message indicating the second channel following transmission of the heartbeat message that de-authorizes the grant of the first channel and in response to the second channel being previously provided to the local SAS by at least one of the geo-redundant instances of the SAS.

Some embodiments of the method include responding, from the local SAS, to the heartbeat messages from the CBSDs for a time interval that is determined based on a predetermined time interval for exchanging status information between peer instances of the SAS.

In some embodiments, the geo-redundant instances of the SAS determine channel and power assignments for the CBSDs based on the status information, and the channel and power assignments are valid for the predetermined time interval.

Some embodiments of the method include receiving, at the local SAS, the status information from at least one of the geo-redundant instances of the SAS and receiving, at the local SAS, information indicating the second channel and login credentials for the ESC.

In some embodiments an apparatus is provided. The apparatus includes at least one processor and at least one memory including computer program code. The at least one memory and the computer program code are configured to, with the at least one processor, cause the apparatus at least to perform aggregating traffic for Citizens Broadband radio Service Devices (CBSDs) in a private enterprise network, monitoring communication with geo-redundant instances of a spectrum access system (SAS) that allocate frequency bands in a shared spectrum to the CBSDs, instantiating a local SAS in response to the geo-redundant instances of the SAS becoming unavailable, and responding to heartbeat messages from the CBSDs.

In some embodiments, an apparatus includes at least one processor and at least one memory storing instructions which, when executed by the at least one processor, cause the apparatus at least to receive, by a domain proxy for a set of spectrum access system (SAS) instances that includes a plurality of regional SAS instances and at least one local SAS instance, SAS load status information that includes, for each of the SAS instances in the set of SAS instances, respective SAS instance load status information for the respective SAS instance and control, by the domain proxy based on at least a portion of the SAS load status information, forwarding of Citizens Broadband radio Service Device (CBSD) traffic toward the set of SAS instances.

In some embodiments, to receive the SAS load status information, the instructions, when executed by the at least one processor, cause the apparatus at least to send, by the domain proxy toward each of the SAS instances in the set of SAS instances, a respective status request message intended for the respective SAS instance, and receive, by the domain proxy from each of the SAS instances in the set of SAS instances, a respective response message for the respective SAS instance that includes the respective SAS instance load status information for the respective SAS instance.

In some embodiments, for at least one of the SAS instances, the respective SAS instance load status information for the respective SAS instance includes at least one of a processing load on the respective SAS instance or a database access load on the respective SAS instance.

In some embodiments, to control forwarding of CBSD traffic toward the set of SAS instances, the instructions, when executed by the at least one processor, cause the apparatus at least to detect, by the domain proxy based on the respective SAS instance load status information for the respective one of the regional SAS instances, a load condition associated with the respective one of the regional SAS instances, and redirect, by the domain proxy based on the load condition associated with the respective one of the regional SAS instances, at least a portion of the CBSD traffic away from the respective one of the regional SAS instances.

In some embodiments, the at least a portion of the CBSD traffic is redirected toward at least a second one of the regional SAS instances.

In some embodiments, the at least a portion of the CBSD traffic is redirected toward one or more of the at least one local SAS instance.

In some embodiments, to control forwarding of CBSD traffic toward the set of SAS instances, the instructions, when executed by the at least one processor, cause the apparatus at least to detect, by the domain proxy based on the respective SAS instance load status information for the respective one of the regional SAS instances, that a load condition previously associated with the respective one of the regional SAS instances has cleared and redirect, by the domain proxy based on the load condition previously associated with the respective one of the regional SAS instances has clearer, at least a portion of the CBSD traffic away from the at least one local SAS instance and toward the respective one of the regional SAS instances.

In some embodiments, an apparatus includes at least one processor and at least one memory storing instructions which, when executed by the at least one processor, cause the apparatus at least to receive, by a local spectrum access system (SAS) instance from a regional SAS instance, Citizens Broadband radio Service (CBRS) Device (CBSD) information for a set of CBSDs associated with the local SAS instance, wherein the CBSD information includes CBSD state information for the set of CBSDs associated with the local SAS instance and channel grant information for the set of CBSDs associated with the local SAS instance, receive, by the local SAS instance from the regional SAS instance, an indication of a completion of a Coordinated Periodic Activities Among SASs (CPAS) computation by the regional SAS instance, and control, by the local SAS instance based on the CBSD information and the indication of the completion of the CPAS computation by the regional SAS instance, CBRS operations for the set of CBSDs associated with the local SAS instance.

In some embodiments, the local SAS instance receives the CBSD information from the regional SAS instance based on a periodic push of the CBSD information by regional SAS instance.

In some embodiments, the local SAS instance receives the CBSD information from the regional SAS instance based on a periodic pull of the CBSD information by the local SAS instance.

In some embodiments, to control the CBRS operations for the set of CBSDs associated with the local SAS instance, the instructions, when executed by the at least one processor, cause the apparatus at least to determine, based on a loss of network connectivity by a private enterprise network hosting the local SAS instance, whether a last data synchronization by the local SAS instance with the regional SAS instance occurred after a successful CPAS computation by the regional SAS instance, and control, by the local SAS based on whether whether the last data synchronization by the local SAS instance with the regional SAS instance occurred after a successful CPAS computation by the regional SAS instance, the CBRS operations for the set of CBSDs associated with the local SAS instance.

In some embodiments, to control the CBRS operations for the set of CBSDs associated with the local SAS instance, the instructions, when executed by the at least one processor, cause the apparatus at least to suspend, by the local SAS instance based on a determination that the last data synchronization by the local SAS instance with the regional SAS instance did not occur after a successful CPAS computation by the regional SAS instance, CBRS operations in the private enterprise network.

In some embodiments, to control the CBRS operations for the set of CBSDs associated with the local SAS instance, the instructions, when executed by the at least one processor, cause the apparatus at least to support, by the local SAS instance based on a determination that the last data synchronization by the local SAS instance with the regional SAS instance did occur after a successful CPAS computation by the regional SAS instance, CBRS operations in the private enterprise network.

In some embodiments, to support CBRS operations in the private enterprise network, the instructions, when executed by the at least one processor, cause the apparatus at least to determine, by the local SAS instance, whether deployment of the set of CBSDs falls within a dynamic protection area (DPA), and respond, by the local SAS instance, to CBSD requests using the CBSD information and based on whether deployment of the set of CBSDs falls within a DPA.

In some embodiments, an apparatus includes at least one processor and at least one memory storing instructions which, when executed by the at least one processor, cause the apparatus at least to provide, by a regional spectrum access system (SAS) instance toward a local SAS instance, a set of Citizens Broadband radio Service Device (CBSD) information associated with a set of CBSDs associated with the local SAS instance, wherein the CBSD information includes CBSD state information for the set of CBSDs associated with the local SAS instance and channel grant information for the set of CBSDs associated with the local SAS instance, and provide, by the regional SAS instance toward the local SAS instance, an indication of a completion of a Coordinated Periodic Activities Among SASs (CPAS) computation by the regional SAS instance.

In some embodiments, the regional SAS instance provides the CBSD information toward the local SAS instance based on a periodic push of the CBSD information by the regional SAS instance.

In some embodiments, the instructions, when executed by the at least one processor, cause the apparatus at least to receive, by the regional SAS instance from the local SAS instance, a push registration request in which the local SAS instance requests to register to receive periodic pushes of CBSD information from the regional SAS instance, and register, by the regional SAS instance based on the push registration request, the local SAS instance to receive periodic pushes of CBSD information from the regional SAS instance.

In some embodiments, the regional SAS instance provides the CBSD information toward the local SAS instance based on a periodic pull of the CBSD information by the local SAS instance. In some embodiments, the instructions, when executed by the at least one processor, cause the apparatus at least to receive, by the regional SAS instance from the local SAS instance, a push registration request in which the local SAS instance requests to register to receive periodic pushes of CBSD information from the regional SAS instance, and register, by the regional SAS instance based on the push registration request, the local SAS instance to receive periodic pushes of CBSD information from the regional SAS instance.

In some embodiments, an apparatus includes at least one processor and at least one memory storing instructions which, when executed by the at least one processor, cause the apparatus at least to receive, by a domain proxy of a private enterprise network including a set of Citizens Broadband radio Service (CBRS) Devices (CBSDs), a spectrum inquiry message of one of the CBSDs, receive, by the domain proxy from a spectrum access system (SAS), a spectrum inquiry response message intended for the one of the CBSDs and including a set of available CBRS channels, modify, by the domain proxy based on a local policy, the spectrum inquiry response message to form a modified spectrum inquiry response message, wherein the spectrum inquiry response message is modified by changing the set of available CBRS channels included in the spectrum inquiry response message, and send, by the domain proxy toward the one of the CBSDs, the modified spectrum inquiry response message.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a communication system according to some embodiments.

FIG. 2 is a block diagram of a network function virtualization (NFV) architecture according to some embodiments.

FIG. 3 is a block diagram illustrating an allocation of frequency bands and an access priority for incumbents, licensed users, and general access users according to some embodiments.

FIG. 4 is a block diagram of a communication system that implements tiered spectrum access according to some embodiments.

FIG. 5 is a block diagram of a communication system that implements a spectrum controller cloud to support deployment of private enterprise networks in a shared spectrum according to some embodiments.

FIG. 6 is a block diagram of communication system including interfaces between CBSDs and an SAS according to some embodiments.

FIG. 7 is a map of the borders of the United States that illustrates a set of dynamic protection areas (DPAs) defined at different geographic locations within the United States according to some embodiments.

FIG. 8 is a block diagram of a communication system that implements primary and secondary SAS instances according to some embodiments.

FIG. 9 is a flow diagram of a method of instantiating and configuring a local SAS instance on a domain proxy according to some embodiments.

FIG. 10 is a flow diagram of a method of operating a local SAS implemented in a domain proxy according to some embodiments.

FIG. 11 is a flow diagram of a method of authorizing a backup channel in response to an incumbent being present in a DPA associated with a domain proxy that implements a local SAS according to some embodiments.

FIG. 12 is a block diagram of a communication system that implements synchronization between a regional SAS instance and local SAS instances according to some embodiments.

FIG. 13 is a flow diagram of a method of implementing a SAS instance according to some embodiments.

FIG. 14 is a flow diagram of a method of operating a local SAS instance for synchronization with a regional SAS instance according to some embodiments.

FIG. 15 is a flow diagram of a method of operating a regional SAS instance for supporting synchronization with local SAS instances according to some embodiments.

FIG. 16 is a flow diagram of a method of operating a regional SAS instance for supporting synchronization with local SAS instances according to some embodiments.

FIG. 17 is a block diagram of a communication system that implements a domain proxy for supporting dynamic control of CBSD traffic for a set of SASs that includes one or more regional SAS instances and a local SAS instance according to some embodiments.

FIG. 18 is a flow diagram of a method of operating a domain proxy for supporting dynamic control of CBSD traffic for a set of SASs that includes one or more regional SAS instances and a local SAS instance according to some embodiments

FIG. 19 is a flow diagram of a method of operating a domain proxy for supporting dynamic control of CBSD traffic for a set of SASs that includes one or more regional SAS instances and a local SAS instance according to some embodiments.

FIG. 20 is a block diagram of a communication system that implements a domain proxy that supports a local co-existence management policy capability according to some embodiments.

FIG. 21 is a flow diagram of a method of supporting a local co-existence management policy capability at a domain proxy according to some embodiments.

FIG. 22 is a flow diagram of a method of supporting a local co-existence management policy capability at a domain proxy according to some embodiments.

FIG. 23 is a flow diagram of a method of operating a domain proxy to support a local co-existence management policy capability according to some embodiments.

### DETAILED DESCRIPTION

The Federal Communication Commission (FCC) has begun offering bands of spectrum owned by federal entities for sharing with commercial operations. For example, newly issued FCC rules in 47 Code of Federal Regulations (CFR) Part 96 allows sharing of the 3550-3700 MHz Citizens Broadband Radio Service (CBRS) between incumbents and other operators. The CBRS operates according to a tiered access architecture that distinguishes between incumbents, operators that have received a priority access license (PAL) consistent with 47 CFR § 96.23, et seq., and general authorized access (GAA) operators that are authorized to implement one or more Citizens Broadband radio Service Devices (CBSDs) consistent with 47 CFR § 96.33, et seq. Incumbents, PAL licensees, and GAA operators are required to request access from a spectrum access system (SAS), which allocates frequency bands to the operators, e.g., for CBRS within the 3550-3700 MHz band. The frequency bands are allocated to the CBSDs associated with the operators within particular geographical areas and, in some cases, during particular time intervals. The SAS determines whether incumbents are present within corresponding geographical areas using an environmental sensing capability (ESC) that performs incumbent detection, e.g., using radar to detect the presence of a Navy ship in a port. Each SAS is able to serve multiple private enterprise networks that include a large number of CBSDs such as base stations, eNodeBs, microcells, picocells, and the like.

The tiered access architecture provides priority access to incumbents, which include Grandfathered Wireless Broadband Licensees that are authorized to operate on a primary basis on frequencies designated in 47 CFR § 96.11. When an incumbent is present in a particular geographical area, the incumbent is granted exclusive access to a portion of the CBRS spectrum. For example, if a Navy ship enters a port, communication systems on the ship are granted exclusive access to frequencies that may impact up to 20 MHz within the lower 100 MHz of the CBRS 3550-3700 MHz band. Operators that have received a PAL and GAA operators are required to vacate the band allocated to the ship. A PAL license grants exclusive access to a portion of the 3550-3700 MHz band within a predetermined geographical area as long as no incumbents have been allocated an overlapping portion of the 3550-3700 MHz band within the predetermined geographical area. The GAA operators are given access to a portion of the 3550-3700 MHz band within a geographic area as long as no incumbents or PAL licensees have been allocated an overlapping portion in the same geographic area during a concurrent time interval. The GAA operators are also required to share the allocated portion of the 3550-3700 MHz band if other GAA operators are allocated the same portion.

Each CBSD that provides wireless connectivity in the CBRS spectrum must be under direct control of an SAS. The CBSDs therefore register with an SAS to begin providing wireless connectivity. The status of the CBSDs is monitored using heartbeat messages exchanged between a registered CBSD and its controlling SAS. The heartbeat messages are exchanged at predetermined time intervals (e.g., 20 seconds, 30 seconds, 60 seconds, and the like) and registration of the CBSD with the SAS is maintained as long as at least one heartbeat message is successfully received within a timeout interval such as 240 seconds or 300 seconds or other timeout interval. A break in the heartbeat messages for more than the timeout interval causes the CBSD to stop their transmissions on the channel granted by the SAS in the CBRS band and thus incur a service downtime that is not acceptable for commercial deployment. In some case, a CBSD (or a domain proxy, DP, which aggregates messages for multiple CBSDs) detects break in the heartbeat messages due to network connectivity issues even though the controlling SAS is functional and continuing to transmit heartbeat messages. The network connectivity issues can include a disruption or degradation of bandwidth associated with an SAS interface network port, backhaul connectivity between the edge cloud infrastructure and an SAS regional cloud, and the like. Service downtime due to a break and network connectivity between a CBSD or DP and the corresponding instance of an SAS is not acceptable for commercial deployments.

One approach to providing high-availability is to implement geo-redundancy, e.g., by associating each CBSD with a primary SAS in one location and a secondary SAS in another location. If the primary SAS goes down, the CBSDs connect to the secondary SAS and resume CBRS band operation. Switching between the primary SAS and the secondary SAS requires that the CBSD stop its current CBRS band operation on the channel granted by the primary SAS to comply with CBRS band rules established by the FCC. The CBRS then transmits a registration request to the secondary SAS to acquire a new channel in the shared spectrum for providing wireless connectivity. The secondary SAS allocates the channel to the CBSD by transmitting a grant message. Implementing geo-redundant SASs (perhaps in combination with techniques to reduce the switching time between the geo-redundant SASs) significantly increases the availability of an SAS to the CBSDs.

However, geo-redundant SASs are vulnerable to other failure modes such as interruption of all the backhaul links to the geo-redundant SASs (e.g., due to a natural disaster) or distributed denial of service (DDOS) attacks that render all the geo-redundant SASs unresponsive. If the geo-redundant SASs remain unresponsive for more than 240 seconds, the CBSDs are required to turn off their transmitters in compliance with the shared spectrum operating rules mandated by the FCC to protect incumbents. Private enterprise networks, particularly those that do not have other connectivity options, can therefore be disrupted indefinitely by the backhaul failure or DDOS attack. Disrupting a private enterprise network by rendering all the geo-redundant SASs unresponsive can interrupt mission critical applications. For example, disrupting the private enterprise network implemented in an energy utility can interrupt the energy supply to an entire community if the disruption lasts longer than 240 seconds.

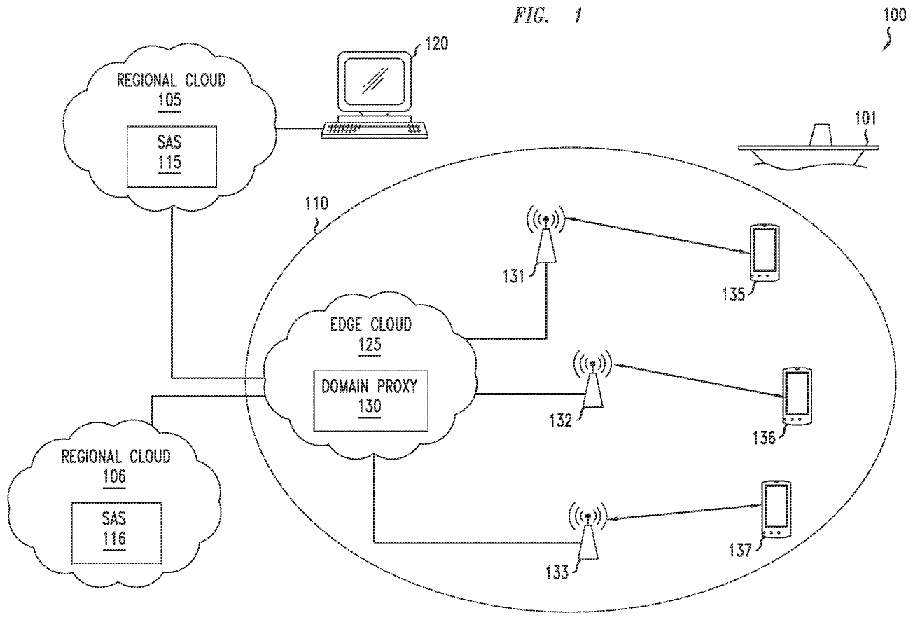

FIGS. 1-11 disclose embodiments of techniques for maintaining service continuity for Citizens Broadband radio Service Devices (CBSDs) in a private enterprise network despite the unavailability of geo-redundant instances of a spectrum access system (SAS) by aggregating traffic for the CBSDs at a domain proxy that implements a local SAS. In response to detecting unavailability of the geo-redundant SASs, the local SAS is configured to respond to heartbeat requests received from the CBSDs. Some embodiments of the local SAS are also configured to provide information indicating valid channels in response to a spectrum inquiry message received from the CBSD and approve grant requests for channels in a valid channel set.

The local SAS also attempts to establish a connection with an environmental sensing capability (ESC) in response to the geo-redundant SASs becoming unavailable. If the connection cannot be established with the ESC, and if the geographic area and spectrum served by the CBSDs overlaps with a dynamic protection area (DPA) defined by a geographic area and a portion of spectrum allocated to an incumbent, the local SAS forces or instructs the CBSDs to switch to a backup channel if the previously granted channels are in a first portion of the Citizens Broadband Radio Service (CBRS) spectrum, e.g., the lower 100 MHz. The backup channel is computed by the primary or secondary SAS considering the presence of other CBSDs that are managed by other vendor SAS's in the same geographic area. The backup channel is either in the upper 50 MHz or the lower 100 MHz of the CBRS band. If the backup channel is in the lower 100 MHz within a DPA, the primary or secondary SAS selects a backup channel that is spatially separated from the originally granted channel by more than 20 MHz (naval radar systems typically impact up to 20 MHz of lower 100 MHz of the CBRS band). If the connection with the ESC is established, and if the ESC reports presence of an incumbent on a channel previously granted to the CBSDs, the local SAS transmits a heartbeat response to the CBSDs that de-authorizes the grant of the channel. Some embodiments of the CBSDs respond with a message including a backup channel. The local SAS grants the backup channel to the CBSDs if the backup channel was previously provided to the local SAS by one of the geo-redundant SASs. The local SAS continues to authorize the channel granted to the CBSDs if the channel does not overlap with the incumbent channel.

The local SAS allows the CBSDs to continue to operate when the geo-redundant SASs are unavailable, e.g., due to a backhaul failure or DDOS attack. In some embodiments, the local SAS supports operation of the CBSDs for a time interval that is determined based on a predetermined time interval for exchanging status information between peer SASs. For example, the SAS instances for different vendors are connected in a mesh configuration to exchange status information for their local CBSDs over SAS-to-SAS interfaces. This information is used to determine channel and power assignments for the CBSDs that are managed by the SAS instances and is exchanged at predetermined time interval such as every 24 hours. The configuration of the CBSDs that is determined based on the exchanged information is valid for the predetermined time interval. The geo-redundant SASs provide the status information to the local SAS so that the status information stored on the local SAS remains valid up to 24 hours after a failure that disrupts the geo-redundant SASs. The geo-redundant SASs also provide backup channel information to the local SAS and the login credentials for the ESC. Thus, the local SAS has the information needed to respond to heartbeat messages from the CBSDs in the absence of the geo-redundant SASs, even if an incumbent appears and impacts the current channel grant. In some embodiments, the local SAS can extend the valid time interval for the status information beyond the predetermined time interval, e.g., for more than 24 hours. For example, a local SAS for CBSDs that serve an inland region that does not overlap with a geographic area served by any other SAS instances, and also not impacted by the presence of any incumbents can use the status information to support the CBSDs indefinitely or until the connectivity issue with the geo-redundant SAS instances on the regional cloud is resolved.

Some embodiments of the domain proxy contain an out of band signaling mechanism (e.g. with a dialup or satellite connection) to receive Presidential Notification e.g., in case of a war, to cease operation in the CBRS band. This out of band signaling mechanism allows the private enterprise network on the edge cloud to comply with the presidential order and cease operation even though it may not be connected to the geo-redundant primary/secondary SAS instances that may have been rendered unresponsive due to e.g. DDOS attack.

Some embodiments of the geo-redundant SAS instances compute additional information (such as the backup channel) every time a new CBSD from the edge cloud private enterprise network registers itself with the regional geo-redundant SAS instances and requests a channel grant, which is downloaded to the local SAS together with status information for an incumbent and other CBSDs that are managed by other SAS vendors in the immediate geographic vicinity of the edge cloud private enterprise network. The domain proxy is configured to monitor the connection with the geo-redundant SAS instances then seamlessly switch operation to the local SAS in response to determining that connections to the geo-redundant SAS instances have been lost. As discussed herein, the local SAS proxy assumes responsibility for responding to CBSD requests within the edge cloud to keep the private enterprise network operational. Consequently, embodiments of the techniques disclosed herein extend the operational window for the CBSDs in the event of a connectivity failure with the regional geo-redundant SAS instances from just 4 minutes to up to 24 hours. This additional time provide operators with more opportunity to resolve the root cause of the problem and resume connectivity between the domain proxy on the edge cloud and the geo-redundant SAS instances on regional clouds. If the edge cloud enterprise network happens to be located within a DPA, and if the domain proxy is unable to establish a connection with the ESC to receive incumbent information within the DPA after losing connectivity with the geo redundant SASs, the local SAS on the domain proxy ensures that the CBSDs use a channel in the upper 50 MHz of the CBRS band (if the regional SAS has computed that channel as a backup channel for the CBSDs). However, if no backup channel in the upper 50 MHz channel is found, the local SAS that is also DPA enabled SAS instance on the domain proxy performs operations assuming that the DPA is enabled for the entire lower 100 MHz in the absence of an ESC sensor. In that case, the transmission power for the Category-A (indoor) and Category-B (outdoor) CBSDs may be configured based on parameters such as the antenna height, tilt, distance from the coastline and ESC sensors to keep the CBRS network operational while complying with the incumbent protection rules within the DPA.

FIG. 1 is a block diagram of a communication system 100 according to some embodiments. The communication system 100 operates in accordance with the FCC rules set forth in 47 Code of Federal Regulations (CFR) Part 96, which allows sharing of the 3550-3700 MHz Citizens Broadband Radio Service (CBRS) between incumbents and other operators. However, some embodiments of the communication system 100 operate in accordance with other rules, standards, or protocols that support sharing of a frequency band between incumbents and other devices such that the frequency band is available for exclusive allocation to an incumbent device if the incumbent device is present in a geographic area. In that case, the other devices are required to vacate any portion of the frequency band that overlaps with another portion of the frequency band that is allocated to the incumbent device. For example, if the communication system 100 is deployed (at least in part) proximate a port and a Navy ship such as an aircraft carrier 101 arrives in the port, devices in a geographic area proximate the port that are providing wireless connectivity in a portion of the frequency band allocated to the aircraft carrier 101 are required to vacate the portion of the frequency band to provide the aircraft carrier 101 with exclusive access to the frequency band within the geographic area.

The communication system 100 includes a regional cloud 105 that provides cloud-based support for a private enterprise network 110. Some embodiments of the regional cloud 105 include one or more servers that are configured to provide operations and maintenance (O&M) management, a customer portal, network analytics, software management, and central security for the private enterprise network 110. The regional cloud 105 also includes an SAS 115 to allocate frequency bands to operators, e.g., to the private enterprise network 110 for CBRS within the 3550-3700 MHz band. The communication system 100 also includes another regional cloud 106 that includes an SAS 116. In the illustrated embodiment, the regional clouds 105, 106 are located at different geographic locations and are therefore used to provide geo-redundancy. The SAS 116 is therefore referred to as a geo-redundant SAS 116 in some cases. The geo-redundant instances of the SAS 115, 116 communicate with each other over an SAS-SAS interface (not shown in FIG. 1 of the interest of clarity). For example, the geo-redundant instances of the SAS 115, 116 exchange status information at a determined time interval such as once every 24 hours. Other SAS-SAS interfaces (not shown in FIG. 1 in the interest of clarity) are also used to exchange status information with other SAS instances associated with other vendors at the predetermined time interval. Some embodiments of the communication system 100 include additional regional clouds and SAS instances, which may or may not be geo-redundant and communicate over corresponding SAS-SAS interfaces. The SASs 115, 116 can serve multiple private enterprise networks, although a single private enterprise network 110 is shown in FIG. 1 in the interest of clarity. Operation of the SASs 115, 116 is disclosed in more detail below.

The regional clouds 105, 106 are configured via user interface portals to one or more external computers 120, although only one is shown in FIG. 1 in the interest of clarity. For example, the external computer 120 provides a customer user interface portal for service management, a digital automation cloud management user interface portal, and an SAS user interface portal that is used to configure the SASs 115, 116. The private enterprise network 110 includes an edge cloud 125 that communicates with the regional clouds 105, 106 to support a plug-and-play deployment of the private enterprise network 110. Some embodiments of the edge cloud 125 support auto configuration and self-service, industrial protocols, local connectivity with low latency, LTE/5G based communication and local security, high availability, and other optional applications for the private enterprise network 110. In the illustrated embodiment, the edge cloud 125 implements a domain proxy 130 that provides managed access and policy control to a set of CBSDs 131, 132, 133 that are implemented using base stations, base station routers, mini-macrocells, microcells, indoor/outdoor picocells, femtocells, and the like. As used herein, the term “base station” refers to any device that provides wireless connectivity and operates as a CBSD in the private enterprise network 110 as either category A CBSD (Indoor), category B CBSD (outdoor), or customer premises equipment (CPE). The CBSDs 131, 132, 133 are therefore referred to herein as the base stations 131, 132, 133 and collectively as “the base stations 131-133.” Some embodiments of the domain proxy 130 are implemented in the regional clouds 105, 106.

The domain proxy 130 mediates between the SASs 115, 116 and the base stations 131-133. In order to utilize the shared spectrum, the base stations 131-133 transmit requests towards one of the SASs 115, 116 to request allocation of a portion of a frequency band. As discussed herein, the domain proxy 130 identifies one of the SASs 115, 116 as a primary SAS that is initially used to support communication in the shared spectrum and the other one of the SASs 115, 116 as a secondary SAS, which is used as a fallback in case of a disruption of service to the primary SAS. The requests include information identifying the portion of the frequency band such as one or more channels, a geographic area corresponding to a coverage area of the requesting base station, and, in some cases, a time interval that indicates when the requested portion of the frequency band is to be used for communication. In the illustrated embodiment, the coverage area of the base stations 131-133 corresponds to the area encompassed by the private enterprise network 110. Some embodiments of the domain proxy 130 reduce the signal load between the domain proxy 130 and the SASs 115, 116 by aggregating requests from multiple base stations 131-133 into a smaller number of messages that are transmitted from the domain proxy 130 to the SASs 115, 116. The base stations 131-133 provide wireless connectivity to corresponding user equipment 135, 136, 137 (collectively referred to herein as “the user equipment 135-137”) in response to the SAS 115 allocating portions of the frequency band to the base stations 131-133.

The requests transmitted by the base stations 131-133 do not necessarily include the same information. Some embodiments of the requests from the base stations 131-133 include information indicating different portions of the frequency band, different geographic areas, or different time intervals. For example, the base stations 131-133 request portions of the frequency band for use in different time intervals if the private enterprise network 110 is deployed in a mall or shopping center and the base stations 131-133 are used to provide wireless connectivity within different stores that have different operating hours. The domain proxy 130 therefore manages the base stations 131-133 using separate (and potentially different) policies on a per-CBSD basis. In some embodiments, the domain proxy 130 accesses the policies for the base stations 131-133 in response to receiving a request from the corresponding base station 131-133. The domain proxy 130 determines whether the base station 131-133 is permitted to access the SAS 115 based on the policy, e.g., by comparing information in the policy to information in one or more mandatory fields of the request. The domain proxy 130 selectively provides the requests to the SASs 115, 116 depending on whether the base station 131-133 is permitted to access the SASs 115, 116. If so, the request is transmitted to the SASs 115, 116 or aggregated with other requests for transmission to the SASs 115, 116. Otherwise, the request is rejected.

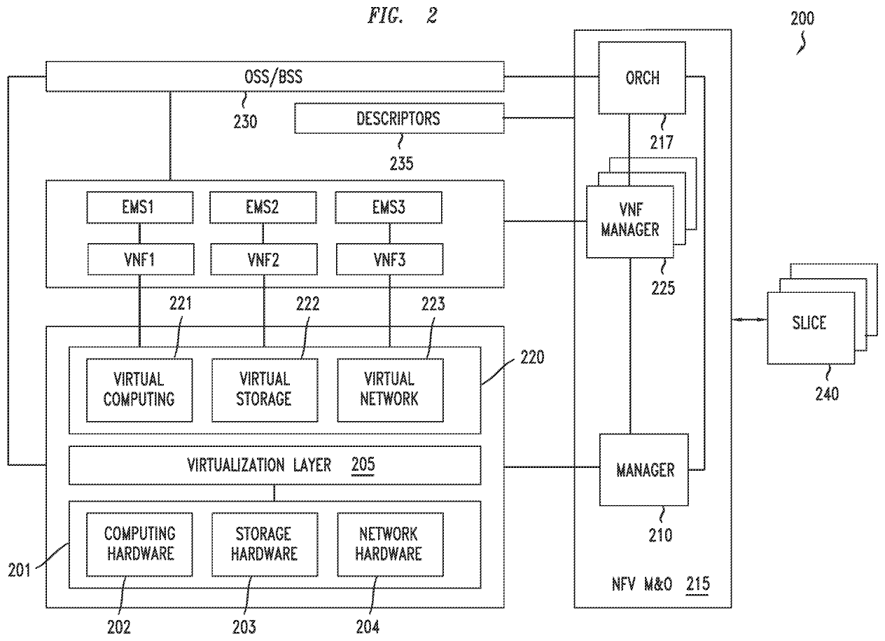

The domain proxy 130 monitors connections with the geo-redundant SASs 115, 116 to determine whether the instances are available. As discussed herein, the geo-redundant SASs 115, 116 can become unavailable due to a failure in a backhaul, a natural disaster, a DDOS attack, or other scenarios. The domain proxy 130 is therefore able to instantiate a local SAS that supports the base stations 131-133 when the geo-redundant SASs are unavailable. In response to detecting unavailability of the geo-redundant SASs 115, 116, the local SAS is configured to respond to heartbeat requests received from the base stations 131-133. Some embodiments of the local SAS are also configured to provide information indicating valid channels in response to a spectrum inquiry message received from the base stations 131-133 and approve grant requests for channels in a valid channel set. The local SAS also attempts to establish a connection with an environmental sensing capability (ESC, not shown in FIG. 1 in the interest of clarity) in response to the geo-redundant SASs 115, 116 becoming unavailable. The actions of the local SAS depend upon the frequency channels allocated to (or requested by) the base stations 131-133, the presence or absence of an incumbent, and whether the local SAS is able to establish the connection with the ESC, as discussed in detail below. FIG. 2 is a block diagram of a network function virtualization (NFV) architecture 200 according to some embodiments. The NFV architecture 200 is used to implement some embodiments of the communication system 100 shown in FIG. 1. For example, the NFV architecture 200 provides the physical resources used to implement the domain proxy 130 shown in FIG. 1, as well as the physical resources used to instantiate the local SAS and other instances of the SAS 115, 116. The NFV architecture 200 includes hardware resources 201 including computing hardware 202 such as one or more processors or other processing units, storage hardware 203 such as one or more memories, and network hardware 204 such as one or more transmitters, receivers, or transceivers. A virtualization layer 205 provides an abstract representation of the hardware resources 201. The abstract representation supported by the virtualization layer 205 can be managed using a virtualized infrastructure manager 210, which is part of the NFV management and orchestration (M&O) module 215. Some embodiments of the manager 210 are configured to collect and forward performance measurements and events that may occur in the NFV architecture 200. For example, performance measurements may be forwarded to an orchestrator (ORCH) 217 implemented in the NFV M&O 215. The hardware resources 201 and the virtualization layer 205 may be used to implement virtual resources 220 including virtual computing 221, virtual storage 222, and virtual networking 223.

Virtual networking functions (VNF1, VNF2, VNF3) run over the NFV infrastructure (e.g., the hardware resources 201) and utilize the virtual resources 220. For example, the virtual networking functions (VNF1, VNF2, VNF3) may be implemented using virtual machines supported by the virtual computing resources 221, virtual memory supported by the virtual storage resources 222, or virtual networks supported by the virtual network resources 223. Element management systems (EMS1, EMS2, EMS3) are responsible for managing the virtual networking functions (VNF1, VNF2, VNF3). For example, the element management systems (EMS1, EMS2, EMS3) may be responsible for fault and performance management. In some embodiments, each of the virtual networking functions (VNF1, VNF2, VNF3) is controlled by a corresponding VNF manager 225 that exchanges information and coordinates actions with the manager 210 or the orchestrator 217.

The NFV architecture 200 may include an operation support system (OSS)/business support system (BSS) 230. The OSS/BSS 230 deals with network management including fault management using the OSS functionality. The OSS/BSS 230 also deals with customer and product management using the BSS functionality. Some embodiments of the NFV architecture 200 use a set of descriptors 235 for storing descriptions of services, virtual network functions, or infrastructure supported by the NFV architecture 200. Information in the descriptors 235 may be updated or modified by the NFV M&O 215.

The NFV architecture 200 can be used to implement network slices 240 that provide user plane or control plane functions. A network slice 240 is a complete logical network that provides communication services and network capabilities, which can vary from slice to slice. User equipment can concurrently access multiple slices. Some embodiments of user equipment provide Network Slice Selection Assistance Information (NSSAI) parameters to the network to assist in selection of a slice instance for the user equipment. A single NSSAI may lead to the selection of several slices. The NFV architecture 200 can also use device capabilities, subscription information and local operator policies to do the selection. An NSSAI is a collection of smaller components, Single-NSSAIs (S-NSSAI), which each include a Slice Service Type (SST) and possibly a Slice Differentiator (SD). Slice service type refers to an expected network behavior in terms of features and services (e.g., specialized for broadband or massive IoT), while the slice differentiator can help selecting among several network slice instances of the same type, e.g. to isolate traffic related to different services into different slices.

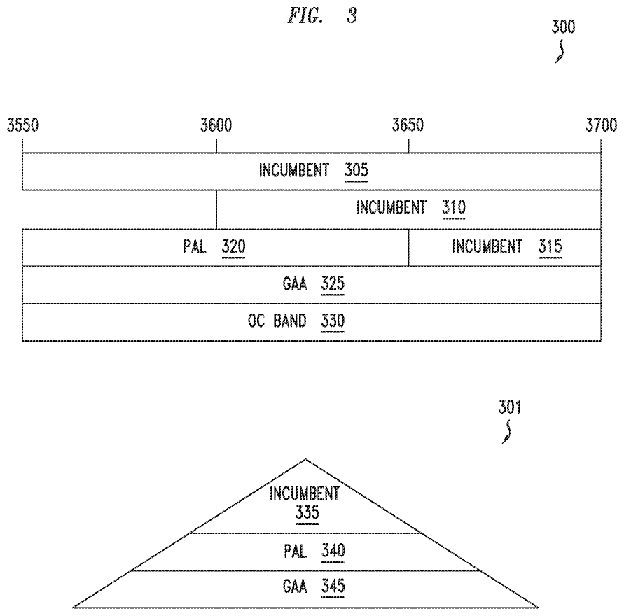

FIG. 3 is a block diagram illustrating an allocation 300 of frequency bands and an access priority 301 for incumbents, licensed users, and general access users according to some embodiments. The allocation 300 and the access priorities 301 are used to determine whether CBSDs such as the base stations 131-133 shown in FIG. 1 are given permission to establish a wireless communication links in portions of the frequency band. The frequency band extends from 3550 MHz to 3700 MHz and therefore corresponds to the spectrum allocated for CBRS. An SAS such as the SASs 115, 116 shown in FIG. 1 allocates portions of the frequency band to devices for providing wireless connectivity within a geographic area. For example, the SAS can allocate 20-40 MHz portions of the frequency band to different devices for use as communication channels.

Portions of the frequency band are allocated to incumbent federal radio location devices, such as Navy ships, from the block 305, which corresponds to all of the frequencies in the available frequency band. Portions of the frequency band are allocated to incumbent FSS receive-only earth stations from the block 310. Portions of the frequency band are allocated to grandfathered incumbent wireless broadband services from the block 315. As discussed herein, the portions of the frequency band are allocated from the blocks 305, 310, 315 for exclusive use by the incumbent.

Operators that have received a priority access license (PAL) consistent with 47 CFR § 96.23, et seq. are able to request allocation of portions of the frequency band in the block 320. The portion of the frequency band that is allocated to an operator holding a PAL is available for exclusive use by the operator in the absence of any incumbents in an overlapping frequency band and geographic area. For example, the SAS can allocate a PAL channel in any portion of the entire 150 MHz of CBRS band as long as it is not pre-empted by the presence of an incumbent. Portions of the frequency band within the block 325 are available for allocation to general authorized access (GAA) operators that are authorized to implement one or more CBSDs consistent with 47 CFR § 96.33, et seq. The GAA operators provide wireless connectivity in the allocated portion in the absence of any incumbents or PAL licensees on an overlapping frequency band and geographic area. The GAA operators are also required to share the allocated portion with other GAA operators, if present. Portions of the frequency band within the block 330 are available to other users according to protocols defined by the Third Generation Partnership Project (3GPP).

The access priority 301 indicates that incumbents have the highest priority level 335. Incumbents are therefore always granted exclusive access to a request to portion of the frequency band within a corresponding geographic area. Lower priority operators are required to vacate the portion of the frequency band allocated to the incumbents within the geographic area. The access priority 301 indicates that PAL licensees have the next highest priority level 340, which indicates that PAL licensees receive exclusive access to an allocated portion of the frequency band in the absence of any incumbents. The PAL licensees are also entitled to protection from other PAL licensees within defined temporal, geographic, and frequency limits of their PAL. The GAA operators (and, in some cases, operators using other 3GPP protocols) received the lowest priority level 345. The GAA operators are therefore required to vacate portions of the frequency band that overlap with portions of the frequency band allocated to either incumbents or PAL licensees within an overlapping geographic area.

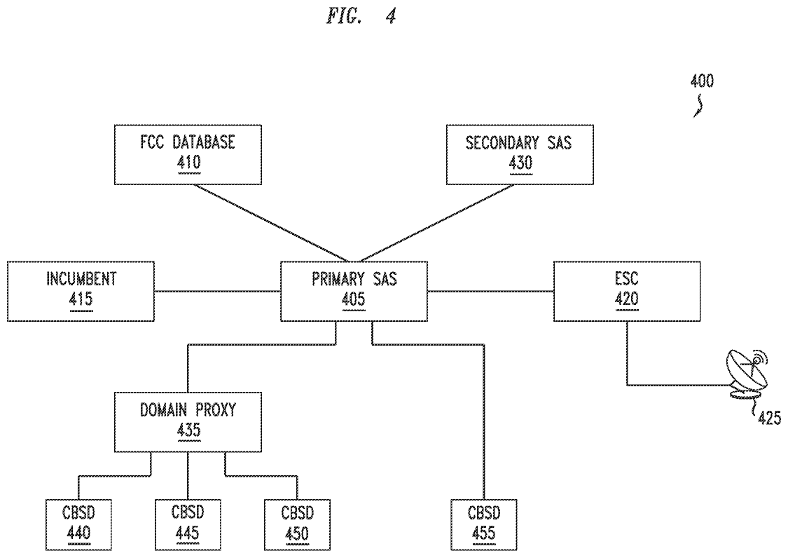

FIG. 4 is a block diagram of a communication system 400 that implements tiered spectrum access according to some embodiments. In the illustrated embodiment, the communication system 400 implements tiered spectrum access in the 3550-3700 CBRS band via a WInnForum architecture. The communication system 400 includes an SAS 405 that performs operations including incumbent interference determination and channel assignment, e.g., for CBRS channels shown in FIG. 3. In the illustrated embodiment, the SAS 405 is a primary SAS. An FCC database 410 stores a table of frequency allocations that indicate frequencies allocated to incumbent users and PAL licensees. An informing incumbent 415 provides information indicating the presence of the incumbent (e.g., a coverage area associated with the incumbent, and allocated frequency range, a time interval, and the like) to the SAS 405. The SAS 405 allocates other portions of the frequency range to provide exclusive access to the informing incumbent 415 within the coverage area. An environmental sensing capability (ESC) 420 performs incumbent detection to identify incumbents using a portion of a frequency range within the geographic area, e.g., using a radar sensing apparatus 425. Some embodiments of the SAS 405 are connected to other SAS 430 via corresponding interfaces so that the SAS 405, 430 coordinate allocation of portions of the frequency range in geographic areas or time intervals. In the illustrated embodiment, the SAS 430 is a secondary SAS that is geo-redundant with the primary SAS 415.

A domain proxy 435 mediates communication between the SAS 405 and one or more CBSD 440, 445, 450 via corresponding interfaces. The domain proxy 435 receives channel access requests from the CBSDs 440, 445, 450 and verifies that the CBSDs 440, 445, 450 are permitted to request channel allocations from the SAS 405. The domain proxy 435 forwards requests from the permitted CBSDs 440, 445, 450 to the SAS 405. As discussed herein, the domain proxy 435 monitors availability of the primary SAS 415 (as well as availability of one or more geo-redundant SAS) and instantiates a local SAS in response to the primary SAS 415 and any geo-redundant SASs becoming unavailable. The local SAS selectively responds to heartbeat messages from the CBSD 440, 445, 450.

In some embodiments, the domain proxy 435 aggregates the requests from the permitted CBSDs 440, 445, 450 before providing the aggregated request to the SAS 405. The domain proxy 435 aggregates requests based on an aggregation function that is a combination of two parameters: (1) a maximum number of requests that can be aggregated into a single message and (2) a maximum wait duration for arrival of requests that are to be aggregated into a single message. For example, if the wait duration is set to 300 ms and the maximum number of requests is 500, the domain proxy accumulates receive requests until the wait duration reaches 300 ms or the number of accumulated requests which is 500, whichever comes first. If only a single request arrives within the 300 ms wait duration, the “aggregated” message includes a single request.

Thus, from the perspective of the SAS 405, the domain proxy 435 operates as a single entity that hides or abstracts presence of the multiple CBSDs 440, 445, 450 and conveys communications between the SAS 405 and the CBSDs 440, 445, 450. One or more CBSD 455 (only one shown in the interest of clarity) are connected directly to the SAS 405 and can therefore transmit channel access requests directly to the SAS 405. Additional discussion of this architecture is provided in Appendix B, from the Wireless Innovation Forum (WinnForum), entitled “Requirements for Commercial Operation in the U.S. 3550-3700 MHz Citizens Broadband Radio Service Band”, Working Document WINNF-TS-0112, Version V1.4.130, Jan. 16, 2018, which is incorporated by reference herein in its entirety.

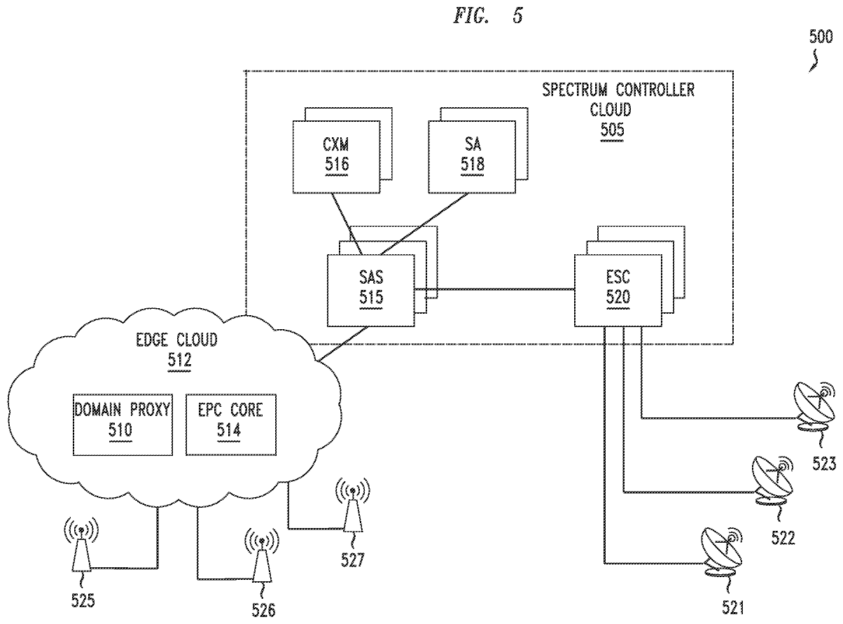

FIG. 5 is a block diagram of a communication system 500 that implements a spectrum controller cloud 505 to support deployment of private enterprise networks in a shared spectrum according to some embodiments. The spectrum cloud controller 505 instantiates a domain proxy 510. In the illustrated embodiment, the domain proxy is situated on an edge cloud 512 to support mission control applications that require high network availability. In other embodiments, the domain proxy 510 is implemented at other locations in the communication system 500. For example, the domain proxy 510 can be implemented a part of a regional cloud to manage one or more different edge cloud infrastructures. The domain proxy 510 manages the edge cloud 512, which also contains a localized EPC core 514. The EPC core 514 provides functionality including LTE EPC operation support system (OSS) functionality, analytics such as traffic analytics used to determine latencies, and the like.

The spectrum controller cloud 505 instantiates multiple SAS instances 515 that support one or more private enterprise networks. Although not shown in FIG. 5, the SAS instances 515 can be connected to other SAS instances, e.g., in other clouds, via corresponding interfaces. Some embodiments of the SAS instances 515 are geo-redundant with each other. One of the SAS instances 515 can therefore be selected as a primary SAS and another one of the SAS instances 515 can be selected as a corresponding secondary SAS. Coexistence management (CXM) functions 516 and spectrum analytics (SA) functions 518 are also instantiated in the spectrum controller cloud 505.

One or more ESC instances 520 are instantiated and used to detect the presence of incumbents. In the illustrated embodiment, standalone ESC sensors 521, 522, 523 (collectively referred to herein as “the sensors 521-523”) are used to monitor a frequency band to detect the presence of an incumbent such as a Navy ship near a port or harbor. The ESC instances 520 notify the corresponding instance of the SAS 515 in response to detecting the presence of an incumbent in a corresponding geographic area. The SAS 515 is then able to instruct non-incumbent devices that serve the geographic area to vacate portions of the spectrum overlapping with the spectrum allocated to the incumbent, e.g., by defining a DPA in terms of a frequency band in a geographic area reserved for the incumbent.

One or more base stations 525, 526, 527 (collectively referred to herein as “the base stations 525-527”) in a private enterprise network communicate with one or more of the domain proxies 510 and the SAS instances 515 via an evolved packet core (EPC) cloud 530. The base stations 525-527 have different operating characteristics. For example, the base station 525 operates according to a PAL in the 3.5 GHz frequency band, the base station 526 operates according to GAA in the 3.5 GHz frequency band, and the base station 525 operates according to a PAL and GAA in the 3.5 GHz frequency band. The base stations 525-527 are configured as Category A (indoor operation with a maximum power of 30 dBm), Category B (outdoor operation with a maximum power of 47 dBm), or CPE. However, in other embodiments, one or more of the base stations 525-527 are configured as either Category A, Category B, or CPE.

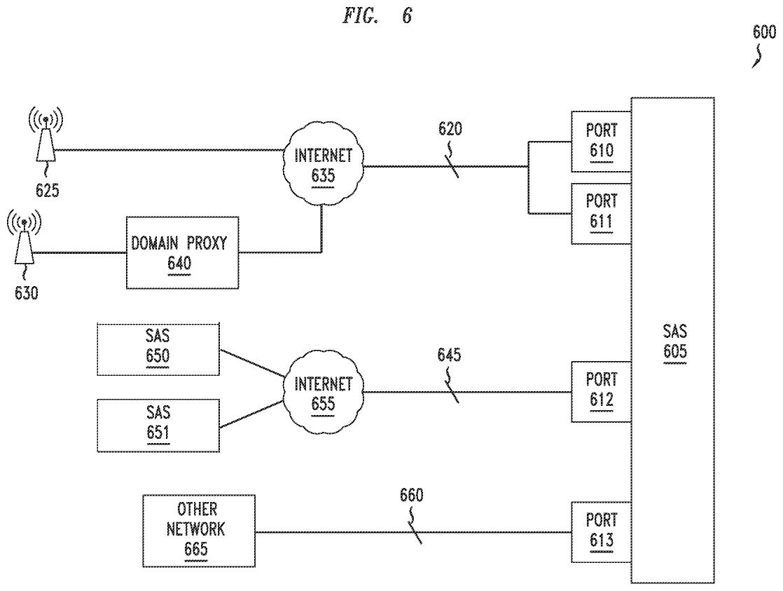

FIG. 6 is a block diagram of communication system 600 including interfaces between CBSDs and an SAS 605 according to some embodiments. The SAS 605 is used to implement some embodiments of the SAS 115 shown in FIG. 1, the SAS 405, 430 shown in FIG. 4, and the instances of the SAS 515 shown in FIG. 5. The SAS 605 includes ports 610, 611, 612, 613 (collectively referred to herein as “the ports 610-613”) that provide access to the SAS 605. In the illustrated embodiment, the SAS 605 is selected as a primary SAS.

An interface 620 supports communication between the SAS 605 and CBSDs 625, 630 via a network such as the Internet 635 and the ports 610, 611. The CBSD 625 is connected directly to the SAS 605 via the interface 620. The CBSD 630 is connected to the SAS 605 via a domain proxy 640 that is connected to the SAS 605 by the interface 620. The domain proxy 640 corresponds to some embodiments of the domain proxy 130 shown in FIG. 1, the domain proxy 435 shown in FIG. 4, and the instances of the domain proxy 510 shown in FIG. 5. An interface 645 supports communication between the SAS 605 and one or more other SASs 650, 651 (only one shown in FIG. 6 in the interest of clarity) via a network such as the Internet 655 and the port 612. The SASs 650, 651 can be owned and operated by other providers. Some embodiments of the SASs 650, 651 are selected as secondary SAS to support the primary SAS 605. An interface 660 supports communication between the SAS 605 and one or more other networks 665 (only one shown in FIG. 6 in the interest of clarity) via the port 613.

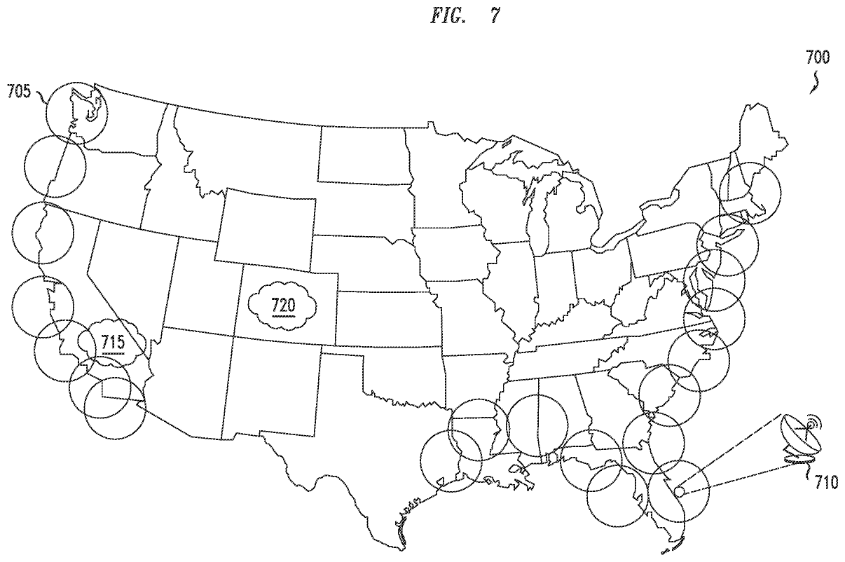

FIG. 7 is a map 700 of the borders of the United States that illustrates a set of dynamic protection areas (DPAs) defined at different geographic locations within the United States according to some embodiments. The DPAs 705 (only one indicated by a reference numeral in the interest of clarity) are typically, but not necessarily, defined near coastal regions to protect incumbents such as Navy ships. A DPA 705 can only be deactivated by an operational ESC sensor and consequently any communication system that uses the CBRS spectrum must include an ESC sensor, such as the ESC sensor 710, to have full access to the CBRS spectrum. The ESC sensors 710 is also required to maintain an exchange of heartbeat messages with the ESC cloud that in turn connects with one or more SAS instances to verify that the ESC sensors 710 within the DPA 705 are operational. If there are no operational ESC sensors deployed within a DPA, FCC rules require that the DPA must be activated throughout the entire 150 MHz CBRS spectrum. In this case, a DPA-enabled SAS assumes that the incumbent is present in the entire lower 100 MHz CBRS band. Based on this assumption, the DPA-enabled SAS takes into consideration the antenna height, tilt, distance from the ESC sensor and coastline of each CBSD (category A or category-B to determine if an appropriate channel grant and transmit power may be allocated for each CBSD for operation within the activated DPA.

Private enterprise networks 715, 720 are deployed to provide service in corresponding geographic areas. In the illustrated embodiment, the private enterprise network 715 is deployed approximate a coastal region and overlaps with one or more DPAs. The private enterprise network 720 is deployed at an inland location and does not overlap with the DPAs shown in FIG. 7. As discussed herein, status information is exchanged between SAS instances at a predetermined time interval, such as every 24 hours. The SAS instances generate configuration information for the CBSDs that are under their control based on the status information. The configurations are considered valid for the predetermined time interval, e.g., configurations of CBSDs in the private enterprise networks 715, 720 remain valid for 24 hours after the exchange of status information between corresponding SAS instances. However, the private enterprise network 720 does not overlap with any DPAs and therefore configuration of the CBSDs in the private enterprise network 720 can remain valid for longer than the predetermined time interval and, in some cases, remains valid indefinitely because the private enterprise network 720 is not impacted by CBSDs in other networks or by incumbents in deployed geographic vicinity.

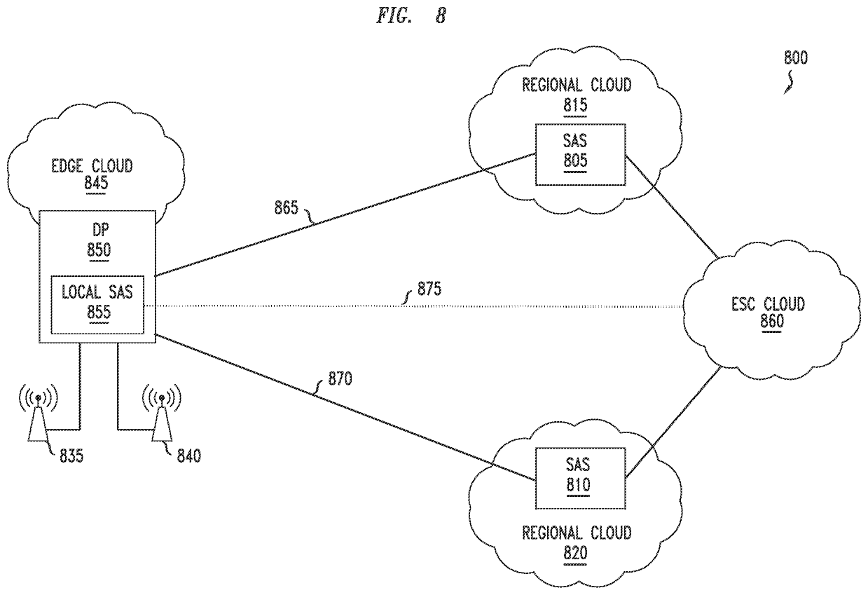

FIG. 8 is a block diagram of a communication system 800 that implements primary and secondary SAS instances 805, 810 according to some embodiments. The primary and secondary SAS instances 805, 810 are implemented in corresponding geo-redundant regional clouds 815, 820. The primary and secondary SAS instances 805, 810 are accessed via corresponding ports using IP addresses that are broadcast or made publicly available. The visibility of the IP addresses that are used to identify the geo-redundant primary and secondary SAS instances 805, 810 makes them vulnerable to malicious attacks such as DDOS attacks, which can potentially make the geo-redundant primary and secondary SAS instances 805, 810 inaccessible, unreachable, or otherwise unavailable. The primary and secondary SAS instances 805, 810 can also become unavailable due to backhaul failures and other events.

The communication system 800 includes CBSDs such as the base stations 835, 840, which are connected to an edge cloud 845 such as the edge cloud 125 shown in FIG. 1. The base stations 835, 840 are connected to a domain proxy 850 such as the domain proxy 130 shown in FIG. 1, which aggregates traffic and instantiates a local SAS 855, as discussed herein. The local SAS 855 is not advertised over external networks and is therefore less vulnerable to attacks such as DDOS attacks. The edge cloud 845 is interconnected with the regional clouds 815, 820, e.g, using a backhaul network (not shown in FIG. 8 in the interest of clarity).

The primary and secondary SAS instances 805, 810 establish connections with an ESC cloud 860 that provides ESC services such as performing incumbent detection and notifying the primary and secondary SAS instances 805, 810 in the event that an incumbent is detected in a DPA that overlaps with the geographic areas served by the primary and secondary SAS instances 805, 810. The domain proxy 850 (or one of the base stations 835, 840) registers with one of the SAS instances 805, 810 as a primary SAS instance and uses the other one of the SAS instances 805, 810 as a geo-redundant secondary SAS instance. In the illustrated embodiment, the domain proxy 850 and the primary SAS 805 establish a connection 865 and the domain proxy establishes a connection 870 with the secondary SAS 810. The domain proxy 850 begins exchanging heartbeat messages with the primary SAS instance 805.

The domain proxy 850 is configured to monitor traffic with all available geo redundant SAS instances (including the primary SAS instance 805 and the secondary SAS instance 810) to perform a seamless switching to the secondary SAS instance 810 if the domain proxy 850 detects a break in connectivity with the primary SAS 805 due to any reason to ensure the high availability of the private enterprise network. Additionally, the domain proxy 850 switches over to the local SAS instance 855 to extend network availability, e.g., beyond the currently specified 4 minutes (240 seconds), if the edge cloud 845 loses connectivity with all geo-redundant SAS instances 805, 810. The domain proxy 850 also attempts to establish a connection 875 to the ESC cloud 860 to ensure that high availability is achieved for deployments along coast lines or other geographic areas that fall under DPA control, e.g., as shown in FIG. 7, which requires the ESC services for operations in the lower 100 MHz of the CBRS band.

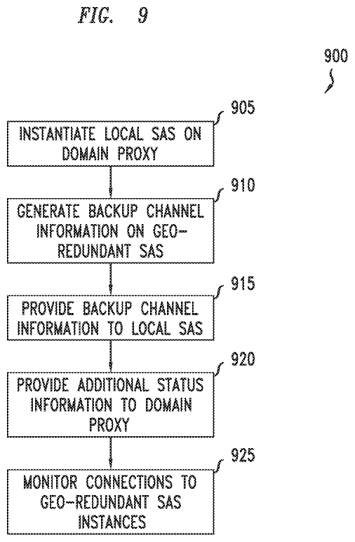

FIG. 9 is a flow diagram of a method 900 of instantiating and configuring a local SAS instance on a domain proxy according to some embodiments. The method 900 is implemented in some embodiments of the communication system 1 shown in FIG. 1 and the communication system 8 shown in FIG. 8, as well as in other embodiments of the domain proxies discussed herein.

At block 905, the domain proxy instantiates a local SAS, which is then configured using information provided by one or more geo-redundant instances of an SAS, such as the geo-redundant SAS instances 805, 810 shown in FIG. 8. Once configured, the local SAS is able to configure the CBSDs in the edge cloud that includes the domain proxy and respond to heartbeat and other messages from the CBSDs, as discussed herein.

At block 910, one or more of the geo-redundant SAS instances generates backup channel information for the CBSDs associated with the domain proxy. In some embodiments, the geo-redundant SAS instances generate the backup channel information considering the presence of other CBSDs that are managed by SAS instances in the same geographic area that are associated with other vendors. The backup channel indicated by the backup channel information is either in the upper 50 MHz or the lower 100 MHz of the CBRS band. If the backup channel is in the lower 100 MHz within a DPA, the geo-redundant instance of the SAS selects a backup channel that is spatially separated from the originally granted channel by an amount that is determined by the characteristics of the incumbent. For example, the geo-redundant instance of the SAS can select a backup channel that is separated from the primary channel by more than 20 MHz because Naval radar systems typically impact up to 20 MHz of lower 100 MHz of the CBRS band.

At block 915, the geo-redundant instance of the SAS provides the backup channel information to the domain proxy, which stores the backup channel information in a database that indicates valid channels for use by the CBSDs in the edge cloud.

At block 920, the geo-redundant instance of the SAS provides additional status information to the domain proxy. In some embodiments, the status information includes status information that is acquired during exchanges with other SAS instances, e.g., via a mesh network. The exchanges are performed at predetermined time intervals such as once every 24 hours. The status information includes credentials that the local SAS uses to establish a connection with an ESC cloud, information identifying DPAs that overlap in frequency or geographic area with the frequencies or geographic areas associated with the edge cloud, presence information indicating whether an incumbent is present in one of the DPAs, status information for other CBSDs that are proximate the CBSDs in the edge cloud, channel and power assignments for the CBSDs that are determined based on the status information, and the like.

At block 925, the domain proxy begins monitoring connections to the geo-redundant instances of the SAS to determine whether the instances are available or reachable. As discussed herein, the domain proxy switches over to the local SAS in response to the geo-redundant instances of the SAS becoming unavailable or unreachable.

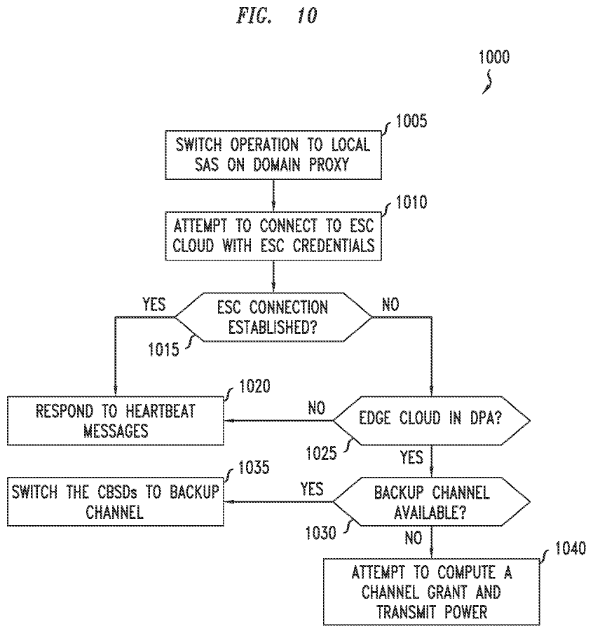

FIG. 10 is a flow diagram of a method 1000 of operating a local SAS implemented in a domain proxy according to some embodiments. The method 1000 is implemented in some embodiments of the communication system 1 shown in FIG. 1 and the communication system 8 shown in FIG. 8, as well as in other embodiments of the domain proxies discussed herein. Domain proxies perform embodiments of the method 1000 in response to the domain proxy determining that the geo-redundant instances of the SAS that support the domain proxy are unavailable or unreachable.

At block 1005, the domain proxy switches over from the geo-redundant instances of the SAS to the local SAS implemented in the domain proxy. As discussed herein, the domain proxy switches to the local SAS in response to determining that the geo-redundant instances of the SAS are unavailable or unreachable.

At block 1010, the local SAS attempts to establish a connection with an ESC cloud using credentials that were previously supplied by one of the geo-redundant instances of the SAS. The local SAS systems to establish the connection in case the edge cloud that hosts the domain proxy is located in or overlaps with a DPA. If the local SAS successfully establishes the connection, the ESC cloud provides information indicating frequency bands, geographic areas, and presence information for incumbents associated with the DPA.

At decision block 1015, the local SAS determines whether the connection was successfully established. If so, the method 1000 flows to block 1020. If the local SAS failed to establish the connection with the ESC cloud, the method 1000 flows to decision block 1025.

At block 1020, the local SAS responds to heartbeat and other messages received from CBSDs in the edge cloud associated with the domain proxy. In some embodiments, the local SAS continues to send authorization OK responses to heartbeat requests from the CBSDs that are under its control on the edge cloud network. If a CBSD sends a spectrum inquiry message, the local SAS responds by sending a response to indicate the valid channels available to the CBSD, e.g., as a valid channel set. If a CBSD sends a grant request for a channel in the valid channel set, the local SAS responds by sending a message that grants the channel to the CBSD. If the channel is not in the valid channel set, the local SAS responds by sending a message that denies the CBSD access to the channel.

At decision block 1025, the local SAS determines whether the edge cloud is located in, or overlapping with, a DPA. In some embodiments, the local SAS determines whether the edge cloud is in, or overlapping with, the DPA based on information that was provided to the local SAS by a geo-redundant instance of the SAS prior to the geo-redundant instance of the SAS becoming unavailable or unreachable. If the edge cloud is not located in or overlapping with the DPA, the method 1000 flows to block 1020. Otherwise, the method flows to decision block 1030.

At decision block 1030, the local SAS determines whether a backup channel in the upper 50 MHz of the CBRS band is available while it is unable to establish connectivity with the ESC cloud. For example, the geo-redundant instances of the SAS may have provided a backup channel in the upper 50 MHz of the CBRS band for use by the CBSDs, as discussed herein. If a backup channel is available, the method 1000 flows to block 1035 and the local SAS instructs the CBSDs to switch to the backup channel. If no backup channel is available, the method 1000 flows to block 1040.

At block 1040, the local SAS that is also a DPA-enabled SAS assumes that the incumbent is present in the entire lower 100 MHz of the CBRS band and attempts to compute a channel grant and transmit power for each CBSD based on its type (Category A o category-B), antenna height, tile, distance from ESC sensor, and coastline. If the DPA-enabled SAS is successful in finding an appropriate channel grant and transmit power to safely operate the CBSD in the DPA while it is not connected to the ESC cloud, it will relay that to the CBSDs in an attempt to keep the private enterprise network operational even after losing connectivity with the regional SAS for a time period that exceed 4 minutes (240 seconds).

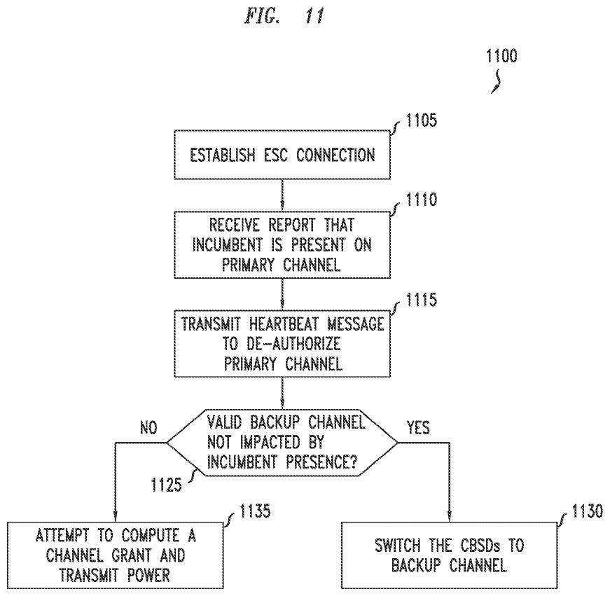

FIG. 11 is a flow diagram of a method 1100 of authorizing a backup channel in response to an incumbent being present in a DPA associated with a domain proxy that implements a local SAS according to some embodiments. The method 1100 is implemented in some embodiments of the communication system 1 shown in FIG. 1 and the communication system 8 shown in FIG. 8, as well as in other embodiments of the domain proxies discussed herein. Domain proxies perform embodiments of the method 1100 in response to the domain proxy determining that the geo-redundant instances of the SAS that support the domain proxy are unavailable or unreachable.

At block 1105, the local SAS successfully establishes a connection with an ESC cloud using credentials provided by a (currently unavailable or unreachable) geo-redundant instance of an SAS.

At block 1110, the local SAS receives a report from the ESC cloud indicating that an incumbent is present in a DPA that overlaps with the edge cloud. The local SAS determines that the CBSDs served by the local SAS are operating on a primary channel that overlaps with the channels defined by the DPA. For example, the local SAS determines that the primary channel granted to the CBSDs is impacted by the presence of the incumbent.

At block 1115, the local SAS transmits a heartbeat response message to de-authorize the channel grant that was provided to CBSDs for the primary channel and forces or instructs the CBSDs to go to a backup channel for operation.

At decision block 1125, the local SAS determines whether the backup channel is a valid channel for use by the CBSDs. In some embodiments, the local SAS previously stored information indicating valid backup channels that were identified by the geo-redundant instances of the SAS and provided to the local SAS. If the backup channel is valid and is not impacted by the incumbent presence, the method 1100 flows to block 1130 and the local SAS transmits a heartbeat response authorizing the backup channel for use by the CBSDs. If the backup channel is not available or is in the lower 100 MHz of the CBRS band, and is also impacted by the incumbent presence, the method 1100 flows to block 1135.

At block 1135, the local SAS that is also DPA enabled SAS assumes that the incumbent is present in the entire lower 100 MHz of the CBRS band and attempts to compute a channel grant and transmit power for each CBSDs based on its type (Category A or category-B), antenna height, tile, distance from ESC sensor, and proximity to a coastline. If the DPA-enabled SAS is successful in finding an appropriate channel grant and transmit power to safely operate the CBSD in the DPA while it is not connected to the ESC cloud, the DPA-enabled SAS relays this information to the CBSDs in an attempt to keep the private enterprise network operational even after losing connectivity with the regional SAS for a time period that exceed 4 minutes (240 seconds).

Some embodiments of the local SAS operate in a holdover mode for a predetermined time interval, such as 24 hours, which is determined by a time interval between SAS-SAS message exchanges that are used to exchange status information. For example, all SASs download data from the FCC, WINNFORUM databases, and peer SASs every 24-hrs. The message exchange allows the SAS instances to acquire and distribute CBSD data for newly registered CBSDs and remove data associated with de-registered CBSDs. The message exchange also distributes data for new incumbents and static incumbents such as FSS, GW, new portal DPAs and the like. In some embodiments, instances of the SAS from all vendors are connected in a mesh configuration and the SAS instances exchange the status information for their CBSDs via SAS-to-SAS interfaces. However, the local SAS instantiated by the domain proxy on the edge cloud is not connected to other vendor's instances of the SAS.

Regional instances of the SAS operated by different vendors perform Coordinated Periodic Activities Among SASs (CPAS) every 24-hrs by exchanging status information for the CBSDs they are managing. The instances of the SAS use the exchanged status information to compute or update channel and power assignments for the CBSDs based on the new snapshot of the CBSDs managed by all SAS instances from all SAS administrators. Accounting to the properties of the different CBSDs allows each instance of the SAS to appropriately protect the incumbents via accurate interference calculations that are performed based on status information for all the CBSDs deployed in the geographic area. If the CBSDs in an edge cloud network fall within a DPA, the instances of the SAS compute backup channel grant list for the CBSDs in addition to the primary channel grant. As discussed herein, information indicating the backup channel grant list is relayed to the local SAS instantiated by the domain proxy on the edge cloud. The local SAS stores the backup channel grant in case the incumbent appears when the regional instances of the SAS are inaccessible and the primary channel grant is impacted by the incumbent presence in the lower 100 MHz.

The regional instances of the SAS also relay login credentials to the domain proxy in the edge cloud if the edge cloud falls within a DPA. As discussed herein, the login credentials are used to establish connectivity with the ESC cloud so that the local SAS can receive service for an ESC region if the domain proxy loses connectivity with all the regional instances of the SAS. The local SAS on the domain proxy uses the incumbent and backup channel grant information to authorize or deny requests from CBSDs in heartbeat REQ-RESP. The local SAS also allows the CBSDs to stay on air even when connection to the regional, geo-redundant instances of the SAS is broken and if an incumbent were to appear and impact the current channel grant.

Results obtained from CPAS are valid for a predetermined time interval such as 24-hrs. By computing all possible (primary and backup channel grants) for CBSDs in a given edge cloud network, and relaying the channel grant list to the local SAS on the domain proxy, embodiments of the techniques disclosed herein ensure that the local SAS instance on the domain proxy on the edge cloud has access to the information needed to keep the network operational for up to 24 hours (and not just for 4 minutes as per the CBRS rule) if connectivity with all the geo-redundant instances of the SAS on the regional cloud is lost. The local SAS also uses the status information to move the CBSDs that are operating in the lower 100 MHz to the free 3650-3700 slots in the event that both the geo-redundant instances of the SAS and the ESC network are offline. In some embodiments, the status information stored at the local SAS does not change significantly, which allows the local SAS to continue to respond to heartbeat messages from the CBSDs and keep the CBSDs online for time intervals longer than 24 hours and, in some cases, indefinitely.

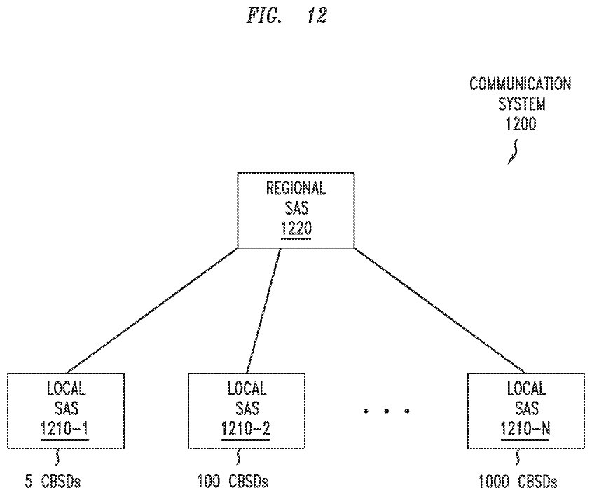

Various example embodiments may be configured to support use of local SASs for handling access by CBSDs to the CBRS based on association of the local SASs with a regional SAS and support for data synchronization between the regional SAS and the local SASs associated with the regional SAS. The data synchronization between a regional SAS and a local SAS that is supporting a set of CBSDs may include providing, from the regional SAS to the local SAS, channel grant information for channels granted to the CBSDs supported by the local SAS. The data synchronization of channel grant information may be performed using pull techniques (e.g., the local SASs pull the relevant data from the regional SAS via requests) and/or push techniques (e.g., the regional SAS pushes the relevant data to the local SASs). The data synchronization between a regional SAS and a local SAS that is supporting a set of CBSDs also may include providing, from the regional SAS to the local SAS, an indication of completion of the CPAS computation as well as the latest channel grant information for the channels granted to the CBSDs supported by the local SAS. It will be appreciated that these and various other example embodiments for supporting data synchronization between the regional SAS and the local SASs to enable use of the local SASs for handling access by CBSDs to the CBRS may be further understood by way of reference to FIGS. 12-16 discussed further below.

FIG. 12 is a block diagram of a communication system that implements synchronization between a regional SAS instance and local SAS instances according to some embodiments.

As depicted in FIG. 12, the communication system 1200 includes a set of local SASs 1210-1 to 1210-N (collectively, local SASs 1210) and a regional SAS 1220. The local SASs 1210 are local to private enterprise networks, respectively, and serve respective sets of CBSDs (omitted for purposes of clarity) associated with the private enterprise networks. It will be appreciated that the local SASs 1210 may serve various different numbers of CBSDs depending on the sizes of the private enterprise networks with which the local SASs 1210 are associated (illustratively, local SAS 1210-1 is indicated as servicing 5 CBSDs, local SAS 1210-2 is indicated as servicing 100 CBSDs, and local SAS 1210-N is indicated as servicing 1000 CBSDs, although it will be appreciated that any local SAS may serve various other numbers of CBSDs). The regional SAS 1220 may be configured to manage each of the CBSDs for each of the local SASs 1210 associated with the regional SAS 1220, such that the regional SAS 1220 may serve large numbers of CBSDs (e.g., tens of thousands of CBSDs, hundreds of thousands of CBSDs, or the like). The regional SAS 1220 maintains CBSD information for each of the CBSDs managed by the local SASs 1210, including CBSD device information received from the local SASs 1210, CBSD channel grant information provided from the regional SAS 1220 to the local SASs 1210, or the like, as well as various combinations thereof). The local SASs 1210 and the regional SAS 1220 are configured to support data synchronization between the regional SAS 1220 and the local SASs 1210 which, as discussed further below, may be performed using pull techniques and/or push techniques.

The local SASs 1210 and the regional SAS 1220 are configured to support data synchronization between the regional SAS 1220 and the local SASs 1210 using pull techniques. In at least some such embodiments, each local SAS 1210 will periodically pull CBSD channel grant information, for the CBSDs supported by the local SAS 1210, from the regional SAS 1220. The local SAS 1210 may periodically pull data from the regional SAS 1220 by sending a request message to the regional SAS 1220 requesting that the regional SAS 1220 provide the latest data for the CBSDs supported by the local SAS 1210. It will be appreciated that any suitable time interval may be used (e.g., every ten seconds, every minute, every five minutes, or the like) and that the time interval may be programmable, dynamic (e.g., dynamically modified for different times of the day, days of the week, or the like, as well as various combinations thereof), and optimized for performance. It will be appreciated that the period that is used for periodic data synchronizations may be uniform across the local SASs 1210 associated with the regional SAS 1220, may vary for different local SASs 1210 associated with the regional SAS 1220, or the like.

The local SASs 1210 and the regional SAS 1220 are configured to support data synchronization between the regional SAS 1220 and the local SASs 1210 using push techniques. In at least some such embodiments, the regional SAS 1220 will periodically push, to each local SAS 1210, CBSD channel grant information for the CBSDs supported by the local SAS 1210, respectively. The regional SAS 1220 may periodically push data to the local SASs 1210 based on registration by the local SASs 1210 with the regional SAS 1220 to receive the periodic data pushes from the regional SAS 1220. The regional SAS 1220 may periodically push data to the local SASs 1210 by sending messages including the data to the local SASs 1210. It will be appreciated that any suitable time interval may be used (e.g., every ten seconds, every minute, every five minutes, or the like) and that the time interval may be programmable, dynamic (e.g., dynamically modified for different times of the day, days of the week, or the like, as well as various combinations thereof), and optimized for performance. It will be appreciated that the period that is used for periodic data synchronizations may be uniform across the local SASs 1210 associated with the regional SAS 1220, may vary for different local SASs 1210 associated with the regional SAS 1220, or the like.

The local SASs 1210 and the regional SAS 1220 are configured to support data synchronization between the regional SAS 1220 and the local SASs 1210 that includes notifications of CPAS computation completion from the regional SAS 1220 to each of the local SASs 1210. The notifications of CPAS completion may be provided from the regional SAS 1220 to the local SASs 1210 since the CPAS computation cannot be performed at the local SASs 1210 due to the computational intensity of the CPAS computation and for privacy reasons (e.g., CBSD information for CBSDs of private enterprise networks of the local SASs 1210 cannot be shared between the local SASs 1210 for privacy reasons, such that none of the local SASs 1210 would have the full set of information needed to perform the CPAS computation locally). The regional SAS 1220 is the one that peers with the other FCC certified Wave-1 and Wave-2 SAS on a nightly basis and, under this mechanism, all SAS vendors exchange Full Activity Dump (FAD) files (including all of the CBSDs and their associated information, such as geographic location, antenna characteristics, category, deployed height, and so forth) used by various SASs for CPAS computations. The regional SAS 1220 receives the FADs from other SASs and performs the CPAS computation based on the FAD files. It will be appreciated that, although the SAS standards have specified a 3-hour CPAS computation completion window, due to the complexity of the computations and the availability of different amounts of compute resources at different SASs, the CPAS computation process may complete sooner or later than the 3 hour CPAS completion window so the local SASs 1210 cannot simple operate based on an assumption that the CPAS computation completed at a particular time. Accordingly, the regional SAS 1220, upon completion of the CPAS computation, provides the notifications of the CPAS computation completion to the local SASs 1210 along with the latest channel grant information for the sets of CBSDs supported by the local SASs 1210, respectively, as this channel grant information is valid to be used by the local SASs 1210 until the completion of the next CPAS computation event.

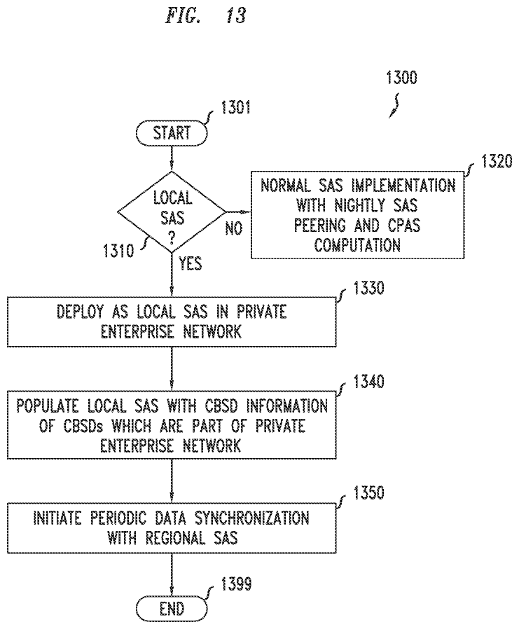

FIG. 13 is a flow diagram of a method of implementing a SAS instance according to some embodiments. It will be appreciated that, although primarily presented herein as being performed serially, at least a portion of the functions of method 1300 may be performed contemporaneously or in a different order than as presented in FIG. 13. At block 1301, the method 1300 begins. At block 1310, a determination is made as to whether the SAS instance is a local SAS or a regional SAS. If the SAS instance is not a local SAS (and, thus, is a regional SAS), then the method 1300 proceeds to block 1320. If the SAS instance is a local SAS, then the method 1300 proceeds to block 1330. At block 1320, the SAS instance is configured using a normal SAS implementation as a regional SAS in which there is nightly SAS peering (with other regional and higher level SASs) and CPAS computations. From the block 1320, the method 1300 proceeds to block 1399 where the method 1300 ends. At block 1330, the SAS instance is deployed as a local SAS in a private enterprise network. At block 1340, the local SAS is populated with CBSD information of CBSDs which are part of the private enterprise network. At block 1350, the local SAS initiates periodic data synchronization with a regional SAS with which the local SAS is associated. From block 1350, the method 1300 proceeds to block 1399 where the method 1300 ends. It will be appreciated that various functions described within the context of the communication system 1200 of FIG. 12 may be implemented within the context of the method 1300 of FIG. 13.

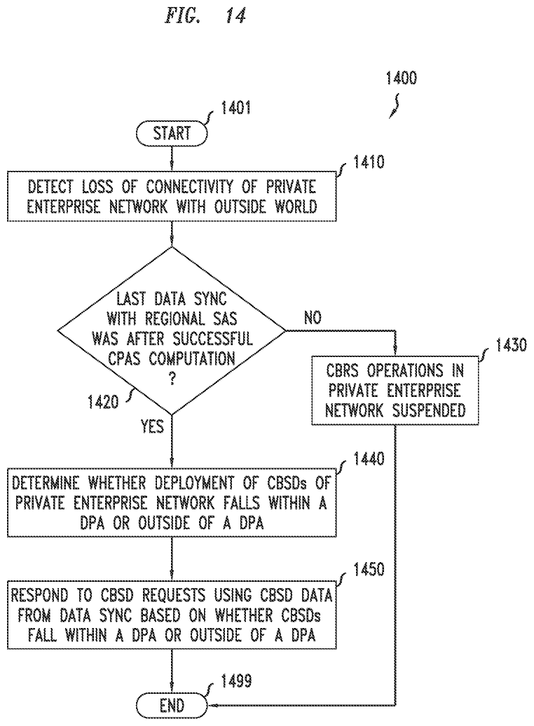

FIG. 14 is a flow diagram of a method of operating a local SAS instance for synchronization with a regional SAS instance according to some embodiments. It will be appreciated that, although primarily presented herein as being performed serially, at least a portion of the functions of method 1400 may be performed contemporaneously or in a different order than as presented in FIG. 14.

At block 1401, the method 1400 begins.

At block 1410, the local SAS detects loss of connectivity of the private enterprise network, at which the local SAS is deployed, with the outside world. The loss of connectivity may be due to networking issues, firewall issues, or the like, as well as various combinations thereof. The loss of connectivity may be detected based on a notification message received by the local SAS from an element of the private enterprise network.

At block 1420, the local SAS determines whether the last data synchronization with the regional SAS was after a successful CPAS computation. The local SAS determines whether the last data synchronization with the regional SAS was after a successful CPAS computation based on the CPAS computation completion notifications that are provided from the regional SAS to the local SAS. If the last data synchronization with the regional SAS was not after a successful CPAS computation, the method 1400 proceeds to block 1430. If the last data synchronization with the regional SAS was after a successful CPAS computation, the method 1400 proceeds to block 1440.

At block 1430, the local SAS suspends CBRS operations in the private enterprise network based on a determination that the last data synchronization with the regional SAS was not after a successful CPAS computation. Here, the local SAS may not have the most recent CBSD information and, thus, cannot rely on the CBSD information that is maintained locally at the local SAS in order to continue CBRS operations for the CBSDs of the private enterprise network. From block 1430, the method 1400 proceeds to block 1499, where the method 1400 ends.

At block 1440, the local SAS continues CBRS operations in the private enterprise network, based on a determination that the last data synchronization with the regional SAS was after a successful CPAS computation, by determining whether the deployment of CBSDs of the private enterprise network fall within a DPA or outside of a DPA. Here, the local SAS has determined that it has the most recent CBSD information and, thus, can rely on the CBSD information that is maintained locally at the local SAS in order to continue CBRS operations for the CBSDs of the private enterprise network. If the CBSDs of the private enterprise network fall within a DPA, then CBRS operations for the CBSDs can continue, with the exception of CBRS operation in the lower 100 MHz (including PAL) due to loss of connectivity with the outside world (and, thus, with the ESC cloud which would provide visibility into operations in the lower 100 MHz of the CBRS). If the CBSDs of the private enterprise network fall outside of a DPA, then CBRS operations for the CBSDs can continue in the entire 150 MHz band of the CBRS. From block 1440, the method 1400 proceeds to block 1450.

At block 1450, the local SAS responds to CBSD requests, using CBSD data from the data synchronization between the regional SAS and the local SAS, based on whether the CBSDs fall within a DPA (in which case, as indicated above, the lower 100 MHz of the CBRS cannot be used) or outside of a DPA (in which case, as indicated above, the entire 150 MHz of the CBRS can be used). From block 1450, the method 1400 proceeds to block 1499 where the method 1400 ends.

At block 1499, the method 1400 ends. It will be appreciated that, although the method 1400 is presented as ending (for purposes of clarity in describing certain functions supported by the local SAS), the method 1400 may continue to be executed by the local SAS for continuing to support CBRS operations for CBSDs of the private data network in which the local SAS is deployed.

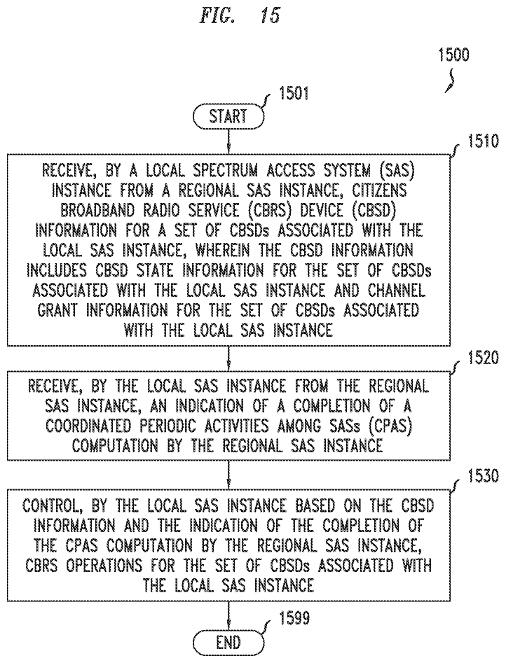

FIG. 15 is a flow diagram of a method of operating a regional SAS instance for supporting synchronization with local SAS instances according to some embodiments. It will be appreciated that, although primarily presented herein as being performed serially, at least a portion of the functions of method 1500 may be performed contemporaneously or in a different order than as presented in FIG. 15. At block 1501, the method 1500 begins. At block 1510, receive, by a local spectrum access system (SAS) instance from a regional SAS instance, Citizens Broadband radio Service (CBRS) Device (CBSD) information for a set of CBSDs associated with the local SAS instance, wherein the CBSD information includes CBSD state information for the set of CBSDs associated with the local SAS instance and channel grant information for the set of CBSDs associated with the local SAS instance. At block 1520, receive, by the local SAS instance from the regional SAS instance, an indication of a completion of a Coordinated Periodic Activities Among SASs (CPAS) computation by the regional SAS instance. At block 1530, control, by the local SAS instance based on the CBSD information and the indication of the completion of the CPAS computation by the regional SAS instance, CBRS operations for the set of CBSDs associated with the local SAS instance. At block 1599, the method 1500 ends.

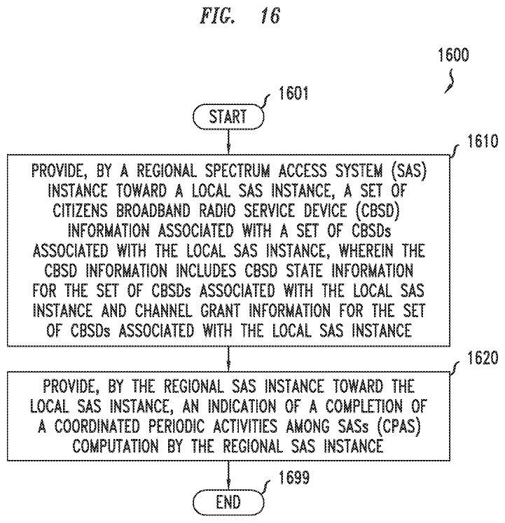

FIG. 16 is a flow diagram of a method of operating a regional SAS instance for supporting synchronization with local SAS instances according to some embodiments. It will be appreciated that, although primarily presented herein as being performed serially, at least a portion of the functions of method 1600 may be performed contemporaneously or in a different order than as presented in FIG. 16. At block 1601, the method 1600 begins. At block 1610, provide, by a regional spectrum access system (SAS) instance toward a local SAS instance, a set of Citizens Broadband radio Service Device (CBSD) information associated with a set of CBSDs associated with the local SAS instance, wherein the CBSD information includes CBSD state information for the set of CBSDs associated with the local SAS instance and channel grant information for the set of CBSDs associated with the local SAS instance. At block 1620, provide, by the regional SAS instance toward the local SAS instance, an indication of a completion of a Coordinated Periodic Activities Among SASs (CPAS) computation by the regional SAS instance. At block 1699, the method 1600 ends.

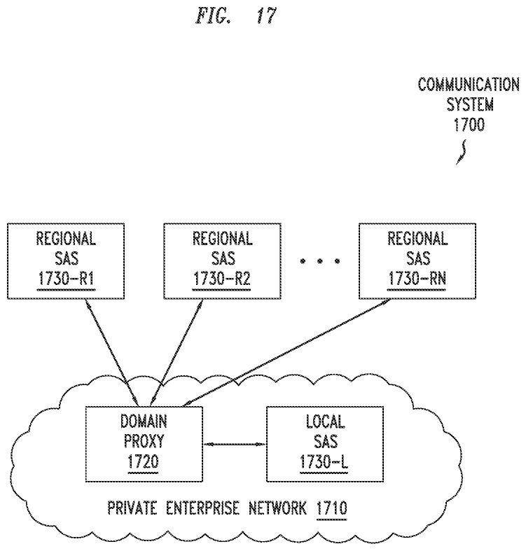

Various example embodiments may be configured to support dynamic control of CBSD traffic for a set of SASs that includes multiple regional SASs and a local SAS. The dynamic control of CBSD traffic for the set of SASs may include performing redistribution of CBSD traffic for at least one of the regional SASs using one or more other SASs in the set of SASs (e.g., one or more other regional SASs, the local SAS, or the like, as well as various combinations thereof) in response to one or more conditions. The dynamic control of the CBSD traffic for the set of SASs may be performed by a private enterprise network that hosts the local SAS. The dynamic control of the CBSD traffic for the set of SASs may be performed by a domain proxy of the private enterprise network that hosts the local SAS. The domain proxy of the private enterprise network may support the dynamic control of the CBSD traffic for the set of SASs by receiving SAS status information for the set of SASs (e.g., SAS status information from each of the SASs in the set of SASs) and performing the dynamic control of the CBSD traffic for the set of SASs based on at least a portion of the SAS status information for the set of SASs (e.g., dynamically moving CBSD traffic from an overloaded regional SAS to a different regional SAS, dynamically moving CBSD traffic from one or more regional SASs to the local SAS based on a determination that the one or more regional SASs are not reachable from the private enterprise network, or the like, as well as various combinations thereof). The domain proxy of the private enterprise network may support the dynamic control of the CBSD traffic for the set of SASs by receiving an indication that the private enterprise network has lost network connectivity and redirecting CBSD traffic intended for the regional SASs toward the local SAS based on a determination that the local SAS is configured to support the CBSD traffic (e.g., the local SAS has the latest CBSD data and the CBSD data is sufficient to keep the CBRS operational until the next CPAS event). It will be appreciated that support for dynamic control of CBSD traffic is configured to provide dynamic SAS performance optimization and enhanced reliability functionality. It will be appreciated that these and various other example embodiments for supporting dynamic control of CBSD traffic for a set of SASs may be further understood by way of reference to FIGS. 17-19 discussed further below.

FIG. 17 is a block diagram of a communication system that implements a domain proxy for supporting dynamic control of CBSD traffic for a set of SASs that includes one or more regional SAS instances and a local SAS instance according to some embodiments.

As depicted in FIG. 17, the communication system 1700 includes a private enterprise network 1710, a domain proxy 1720, and a set of SAS instances 1730. The private enterprise network 1710 includes the domain proxy 1720 and a local SAS instance 1730-L that is part of the set of SAS instances 1730. The private enterprise network 1710 supports a set of CBSDs (which are omitted for purposes of clarity). The set of SAS instances 1730 also includes a set of regional SAS instances 1730-R1 to 1730-RN (collectively, regional SAS instances 1730) available to support the private enterprise network 1710. The SAS instances in the set of SAS instances 1730 are configured to support CBSD traffic of the CBSDs supported by the private enterprise network 1710. It will be appreciated that the communication system 1700 may include fewer or more elements, as well as various other elements, which may support CBRS service for the private enterprise.

The domain proxy 1720 may support dynamic control of CBSD traffic for the private enterprise network 1710 based on the set of SAS instances 1730. The domain proxy 1720 may maintain connectivity with each of the SAS instances 1730. The domain proxy 1720 may receive SAS status information from each of the SAS instances 1730 and maintain the SAS status information for each of the SAS instances 1730 for use in performing dynamic control of CBSD traffic for the private enterprise network 1710 based on the set of SAS instances 1730. The SAS status information for a SAS instance 1730 that is provided from the SAS instance 1730 to the domain proxy 1720 may include an indication of a status of the connectivity between the domain proxy 1720 and the SAS instance 1730 (whether or not SAS instance 1730 is reachable by the domain proxy 1720), SAS instance load information that is indicative of a load on the SAS instance 1730 (e.g., CPU processing load, database access load, or the like, as well as various combinations thereof), or the like, as well as various combinations thereof. The SAS status information for the local SAS instance 1730-L that is provided from the local SAS instance 1730-L to the domain proxy 1720 also may include an indication as to whether a successful data sync was achieved with one of the regional SAS instances 1730-R after conclusion of the most recent CPAS computation event (in which case the local SAS instance 1730-L has CBSD state data that is not stale and, thus, that can be used to continue CBRS operations for the private enterprise network 1710). The SAS status information for a SAS instance 1730 that is provided from the SAS instance 1730 to the domain proxy 1720 may include various other types of SAS status information.

The domain proxy 1720 may maintain connectivity with the SAS instances 1730 and obtain the SAS status information from each of the SAS instances 1730 based on a protocol that supports periodic exchanging of messages between the domain proxy 1720 and each of the SAS instances 1730. For example, the domain proxy 1720 may periodically send system status request messages to the SAS instances 1730 and the SAS instances 1730 may respond to the system status request messages by sending system status response messages to the domain proxy 1720. The system status response messages from the SAS instances 1730 may serve as heartbeat messages so that the domain proxy 1720 can determine whether or not there is still connectivity from the domain proxy 1720 to the SAS instances 1730. The system status response messages from the SAS instances 1730 also may be used to transport the SAS status information provided from the SAS instances 1730 to the domain proxy 1720. The periodicity of the system status request/response messages may be any suitable duration (e.g., every 10 seconds, every 20 seconds, every minute, or the like). The periodicity of the system status request/response messages may be dynamically tunable. It will be appreciated that various other types of request messages and/or response messages may be employed by the domain proxy 1720 for maintaining connectivity with the SAS instances 1730 and obtain the SAS status information from each of the SAS instances 1730.

The domain proxy 1720 may support dynamic control of CBSD traffic for the private enterprise network 1710 using the SAS instances 1730. The domain proxy 1720 may support dynamic control of CBSD traffic for the private enterprise network 1710 based on the SAS status information from the SAS instances 1730. The dynamic traffic control performed by the domain proxy 1720 based on the SAS status information may include dynamic load balancing of CBSD traffic, such as by directing CBSD traffic from an overloaded regional SAS instance 1730-R to one or more other SAS instances 1730 (e.g., one or more other regional SAS instances 1730-R and/or the local SAS instance 1730-L) which have capacity to handle the additional CBSD traffic. The dynamic traffic control performed by the domain proxy 1720 based on the SAS status information may include directing CBSD traffic from an unavailable regional SAS instance 1730-R (e.g., where a determination is made that the domain proxy 1720 has lost connectivity with that regional SAS instance 1730-R) to one or more other SAS instances 1730 (e.g., one or more other regional SAS instances 1730-R and/or the local SAS instance 1730-L) that still have connectivity to the domain proxy 1720. The dynamic traffic control performed by the domain proxy 1720 based on the SAS status information may include redirecting all CBSD traffic toward the local SAS instance 1730-L based on a determination that the domain proxy 1720 has lost connectivity to all of the regional SAS instances 1730 and based on a determination that the local SAS instance 1730-L is configured to support the CBSD traffic (e.g., the local SAS instance 1730-L has the latest CBSD data and the CBSD data is sufficient to keep the CBRS operational until the next CPAS event). The dynamic traffic control performed by the domain proxy 1720 based on the SAS status information may include directing CBSD traffic from the local SAS instance 1730-L toward one or more regional SAS instances 1730-R (e.g., based on a determination that the one or more regional SAS instances 1730-R have capacity to support additional CBSD traffic, based on a determination that the one or more regional SAS instances 1730 were previously experiencing high load conditions which have since cleared, based on a determination that the one or more regional SAS instances 1730 became available after being unavailable, or the like, as well as various combinations thereof). It will be appreciated that, although primarily presented with respect to example embodiments in which the domain proxy 1720 supports specific types of dynamic traffic control (e.g., in terms of one or more of the SAS instances 1730 from/to which CBSD traffic is moved, conditions that cause movement of CBSD traffic between SAS instances 1730, or the like, as well as various combinations thereof), the domain proxy 1720 may support various other types of dynamic traffic control (e.g., in terms of one or more of the SAS instances 1730 from/to which CBSD traffic is moved, conditions that cause movement of CBSD traffic between SAS instances 1730, or the like, as well as various combinations thereof).

The domain proxy 1720, as indicated above, may support dynamic control of CBSD traffic for the private enterprise network 1710 using the SAS instances 1730, based on the SAS status information of the SAS instances 1730, by dynamically directing CBSD traffic to various SAS instances based on SAS load information of the SAS instances 1730. If a SAS instance 1730 is under an overload condition (e.g., based on CPU load, DB access load, or the like), addition of new CBSDs and their associated CBSD traffic to its processing load will only exacerbate the already compromised performance of the SAS instance 1730 and, potentially, SAS in general. Without a mechanism to address this scenario, it is possible that the SAS performance will deteriorate to a point that all of the CBSDs being managed by the SAS instance 1730 are impacted and, potentially, that all CBSDs being managed across the SAS will be impacted. In other words, this may result in a meltdown scenario in which there may be widespread CBRS network outages that can impact multiple, many, or even all private enterprise networks supported by the SAS (not necessarily just the subset of private enterprise networks that are being managed by any particular SAS instance 1730). It is noted that, while use of heartbeat messages to ensure that there is still connectivity between the domain proxy 1720 and a SAS instance 1730 is useful for directing CBSD traffic away from unavailable SAS instances 1730, such heartbeat messages, in the absence of additional SAS instance load information, may be insufficient to protect against the load-based performance degradation scenarios discussed above (e.g., because the overloaded SAS instance 1730 may be able to respond to heartbeat messages when heavily loaded or overloaded, but may not be able to adequately handle CBSD traffic while in the heavily or overloaded state. The domain proxy 1720 may support dynamic performance optimization of the SAS by operating to protect the SAS against such load conditions. The domain proxy 1720 may protect the SAS against such load conditions by taking into consideration the actual load on each SAS instance 1730 when directing CBSD traffic toward the SAS instances 1730. For example, the domain proxy 1720, based on a determination that one of the SAS instances 1730 is experiencing a load condition, may dynamically redirect some or all of the CBSD traffic (e.g., for existing CBSDs being managed by the overloaded SAS instance 1730 and/or for new CBSDs that need to be directed to SAS instances 1730 for management) to one or more other SAS instances 1730 which are not experiencing load conditions. It is noted that, while use of SAS instance load information to control CBSD traffic is primarily presented from the perspective of a single domain proxy 1720 of a single private enterprise network 1710, use of SAS instance load information to control CBSD traffic may be applied across multiple private enterprise networks which are utilizing the SAS system for CBSD management (or even all private enterprise networks which interact with the SAS system), thereby resulting in higher SAS reliability and availability for the SAS system as a whole as each of the domain proxies of each of the private enterprise networks operates to dynamically optimize distribution of CBSD traffic within the SAS system.

It will be appreciated that the communication system 1700 may include various other elements configured to support dynamic control of CBSD traffic for a set of SAS instances that includes one or more regional SAS instances and a local SAS instance.

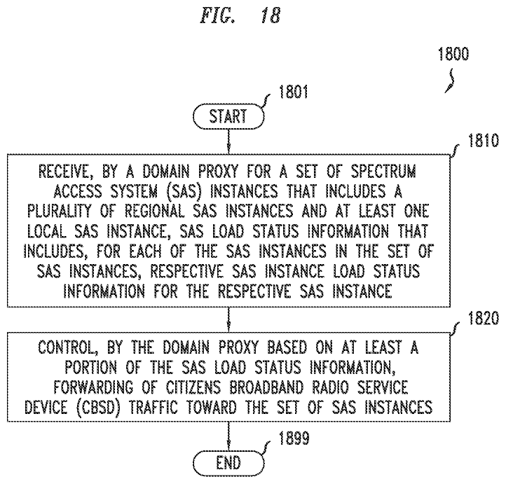

FIG. 18 is a flow diagram of a method of operating a domain proxy for supporting dynamic control of CBSD traffic for a set of SASs that includes one or more regional SAS instances and a local SAS instance according to some embodiments. It will be appreciated that, although primarily presented herein as being performed serially, at least a portion of the functions of method 1800 may be performed contemporaneously or in a different order than as presented in FIG. 18. At block 1801, the method 1800 begins. At block 1810, receive, by a domain proxy for a set of spectrum access system (SAS) instances that includes a plurality of regional SAS instances and at least one local SAS instance, SAS load status information that includes, for each of the SAS instances in the set of SAS instances, respective SAS instance load status information for the respective SAS instance. At block 1820, control, by the domain proxy based on at least a portion of the SAS load status information, forwarding of Citizens Broadband radio Service Device (CBSD) traffic toward the set of SAS instances. At block 1899, the method 1800 ends.

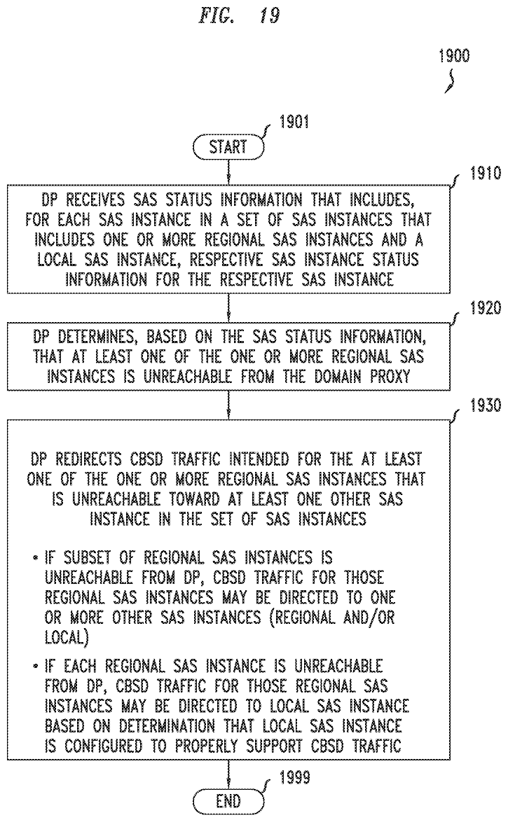

FIG. 19 is a flow diagram of a method of operating a domain proxy for supporting dynamic control of CBSD traffic for a set of SASs that includes one or more regional SAS instances and a local SAS instance according to some embodiments. It will be appreciated that, although primarily presented herein as being performed serially, at least a portion of the functions of method 1900 may be performed contemporaneously or in a different order than as presented in FIG. 19. At block 1901, the method 1900 begins. At block 1910, the domain proxy receives SAS status information that includes, for each SAS instance in a set of SAS instances that includes one or more regional SAS instances and a local SAS instance, respective SAS instance status information for the respective SAS instance. At block 1920, the domain proxy determines, based on the SAS status information, that at least one of the one or more regional SAS instances is unreachable from the domain proxy. At block 1930, the domain proxy redirects CBSD traffic intended for the at least one of the one or more regional SAS instances that is unreachable toward at least one other SAS instance in the set of SAS instances. If a subset of the regional SAS instances is unreachable from the domain proxy, the CBSD traffic for those regional SAS instances may be directed to one or more other SAS instances (e.g., one or more other regional SAS instances still reachable from the domain proxy, the local SAS instance co-located with the domain proxy where the local SAS instance is configured to properly support the CBSD traffic, or the like, as well as various combinations thereof). If each of the regional SAS instances is unreachable from the domain proxy, the CBSD traffic for those regional SAS instances may be directed to the local SAS instance based on a determination that the local SAS instance is configured to properly support the CBSD traffic (e.g., the local SAS instance has the latest CBSD data and the CBSD data is sufficient to keep the CBRS operational until the next CPAS event). At block 1999, the method 1900 ends.

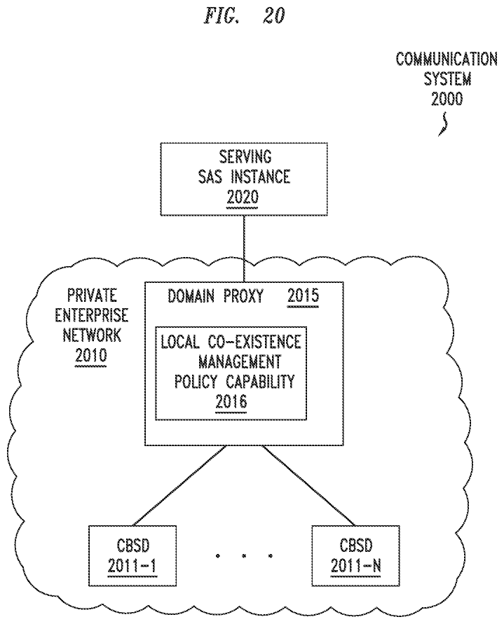

Various example embodiments may be configured to support a domain proxy local co-existence management policy capability configured to support control over CBRS channel assignments for CBSDs of a private enterprise network. The local co-existence management policy capability enables a private enterprise network to optimize CBRS network performance at the private enterprise network. The local co-existence management policy capability enables a domain proxy of a private enterprise network to optimize CBRS network performance at the private enterprise network by influencing CBRS channel assignments received from the serving SAS instance for CBSDs of the private enterprise network to optimize the CBRS channel assignments for the CBSDs of the private enterprise network. The domain proxy of the private enterprise network may influence channel assignments received from the serving SAS instance for CBSDs of the private enterprise network, to optimize the channel assignments for the CBSDs of the private enterprise network, by overriding the available CBRS channels as proposed by the serving SAS instance to a subset of available CBRS channels that is an intersection of the available CBRS channels listed in local co-existence policies for the CBSDs and then forwarding the modified CBRS available channel list to the CBSDs for use by the CBSDs in selecting the CBRS channels to be used to achieve improved or even optimal CBRS network performance for the private enterprise network. It will be appreciated that these and various other example embodiments for supporting a domain proxy local co-existence management policy capability configured to support control over CBRS channel assignments for CBSDs of a private enterprise network may be further understood by way of reference to FIGS. 20-23 discussed further below.

FIG. 20 is a block diagram of a communication system that implements a domain proxy that supports a local co-existence management policy capability according to some embodiments.

As depicted in FIG. 20, the communication system 2000 includes a private enterprise network 2010 and a serving SAS instance 2020 configured to support CBRS service channel grants for the private enterprise network 2010. The private enterprise network 2010 includes a set of CBSDs 2011-1 to 2011-N (collectively, CBSDs 2011) and a domain proxy 2015. The domain proxy 2015 may be configured to facilitate CBRS channel grant communications between the CBSDs 2011 and the serving SAS instance 2020 for granting of CBRS channels to the CBSDs 2011 of the private enterprise network 2010 by the serving SAS instance 2020. The domain proxy 2015 includes a local co-existence management policy capability 2016 which enables the domain proxy 2015 to facilitate improved CBRS channel grants to the CBSDs 2011 to achieve improved or even optimal CBRS network performance for the private enterprise network 2010. It will be appreciated that the serving SAS instance 2020 that grants CBRS channels to the CBSDs 2011 may include one or more SAS instances which may be configured to support CBRS channel grants for the private enterprise network 2010 (e.g., one or more regional SAS instances, one or more local SAS instances associated with the private enterprise network 2010, or the like, as well as various combinations thereof). It will be appreciated that the communication system 2000 may include various other elements or capabilities which may support CBRS service for the private enterprise network 2010.

As depicted in FIG. 20, the domain proxy 2015 includes a local co-existence management policy capability 2016 which enables the domain proxy 2015 to facilitate improved CBRS channel grants to the CBSDs 2011. A CBSD 2011, before requesting a CBRS channel grant from the serving SAS instance 2020, sends a spectrum inquiry message to inquire about the CBRS channels available for selection by that CBSD 2011. The serving SAS instance 2020 receives the spectrum inquiry message and responds with spectrum inquiry response message including a list of available CBRS channels available for use by the CBSD for CBRS operations. The CBSD 2011 receives the spectrum inquiry response message from the serving SAS instance 2020, selects one of the available CBRS channels from the available CBRS channel list, and sends a channel grant request to the service SAS instance 2020 to request grant of the selected CBRS channel for use by the CBSD 2011. The serving SAS instance 2020 will either accept or reject the CBRS channel grant, but will not override the CBRS channel grant request by granting a different CBRS channel. As such, when there are several CBSDs deployed in an enterprise network, such as the CBSDs 2011 deployed in the private enterprise network 2010, some of them may be co-located or located close enough to have overlapping coverage areas such that, if the serving SAS instance 2020 responds to several CBSDs 2011 with overlapping lists of available CBRS channels, there may be conflicts between CBRS channel grants if some of the CBSDs 2011 select the same CBRS channels when requesting CBRS channel grants (since they operate independently of each other) from the serving SAS instance 2020. For example, if these CBSDs 2011 operate in a geographic area with an incumbent, the serving SAS instance 2020 may grant the CBSDs 2011 the same channel, but with EIRP that is much lower than their category (indoor or outdoor) max EIRP to avoid collective impact to the incumbent, which will result not only result in reduced RF coverage area for each adjacent CBSD 2011 using the same channel, but also poor CBRS network performance for the private enterprise network 2010 overall.

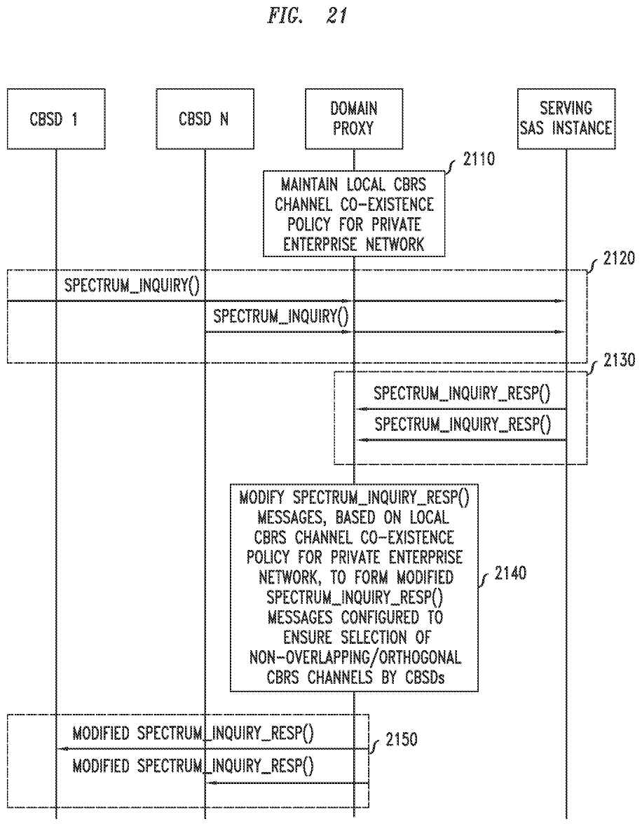

As depicted in FIG. 20, the domain proxy 2015 may be configured to use the local co-existence management policy capability 2016 to overcome such limitations and facilitate improved CBRS channel grants to the CBSDs 2011. The domain proxy 2015 may be configured to use the local co-existence management policy capability 2016 to overcome such limitations and facilitate improved CBRS channel grants to the CBSDs 2011 by modifying the available CBRS channel lists in the spectrum inquiry response messages provided from the serving SAS instance 2020 to the CBSDs 2011 in a manner tending to prevent the CBSDs 2011 from selecting the same CBRS channels to use for CBRS operations at the private enterprise network 2010. The domain proxy 2015 may be configured to use the local co-existence management policy capability 2016 to overcome such limitations and facilitate improved CBRS channel grants to the CBSDs 2011 by intercepting the spectrum inquiry response messages provided from the serving SAS instance 2020 to the CBSDs 2011, modifying the available CBRS channel lists in the spectrum inquiry response messages provided from the serving SAS instance 2020 to the CBSDs 2011 to form modified spectrum inquiry response messages, and providing the modified spectrum inquiry response messages to the CBSDs 2011 for influencing the CBRS channels selected by the CBSDs 2011 in a manner that tends to prevent the CBSDs 2011 from selecting the same CBRS channels to use for CBRS operations at the private enterprise network 2010 and, thus, improves the CBRS network performance of the private enterprise network 2010. It will be appreciated that this capability of the domain proxy 2015 may be further understood by way of reference to FIGS. 21-23 as discussed further below.

FIG. 21 is a flow diagram of a method of supporting a local co-existence management policy capability at a domain proxy according to some embodiments. It will be appreciated that, although primarily presented herein as being performed serially, at least a portion of the functions of method 2100 may be performed contemporaneously or in a different order than as presented in FIG. 21.

At block 2110, the domain proxy of a private enterprise network maintains a local CBRS channel co-existence policy for the private enterprise network. The local CBRS channel co-existence policy for the private enterprise network may specify, for each of one or more of the CBSDs of the private enterprise network, a set of CBRS channels which may be requested by the respective CBSD such that the set of CBSDs of the private enterprise network requests non-overlapping/orthogonal CBRS channels. The local CBRS channel co-existence policy may be based on radio frequency (RF) engineering, one or more self-organizing network (SON) algorithms, or the like, as well as various combinations thereof.

At block 2120, the CBSDs send Spectrum_Inquiry( ) messages, inquiring about available CBRS channels for the CBSDs, to the serving SAS instance via the domain proxy.

At block 2130, the serving SAS instance sends Spectrum_Inquiry_Resp( ) messages toward the CBSDs in response to the Spectrum_Inquiry( ) messages of the CBSDs and the domain proxy intercepts Spectrum_Inquiry_Resp( ) messages sent by the SAS service toward the CBSDs in response to the Spectrum_Inquiry( ) messages of the CBSDs. The Spectrum_Inquiry_Resp( ) message sent to a CBSD may include a list of available CBRS channels that are available for selection by the CBSD to obtain a CBRS channel grant from the serving SAS instance.

At block 2140, the domain proxy modifies one or more Spectrum_Inquiry_Resp( ) messages, based on the local CBRS channel co-existence policy for the private enterprise network, to form modified Spectrum_Inquiry_Resp( ) messages that are configured to ensure selection of non-overlapping/orthogonal CBRS channels by the CBSDs. The modification of a Spectrum_Inquiry_Resp( ) message for a CBSD to form a modified Spectrum_Inquiry_Resp( ) message for the CBSD may include modification of the list of available CBRS channels that are available for selection by the CBSD. In other words, the domain proxy overrides the CBRS channel lists proposed by the SAS service to ensure selection of non-overlapping/orthogonal CBRS channels by the CBSDs. This protects against instances in which the SAS service sends the same set of available CBRS channels to the CBSDs and the CBSDs end up selecting the same CBRS channels to use for CBRS operation.

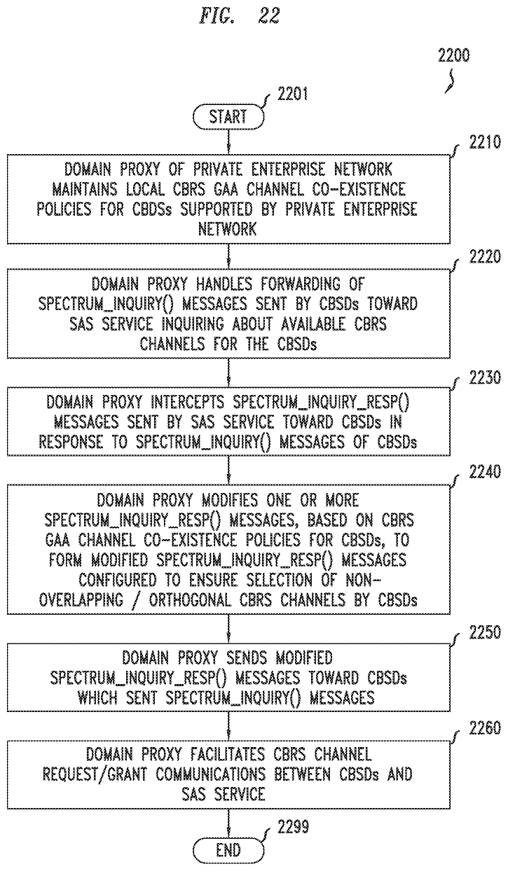

FIG. 22 is a flow diagram of a method of supporting a local co-existence management policy capability at a domain proxy according to some embodiments. It will be appreciated that, although primarily presented herein as being performed serially, at least a portion of the functions of method 2200 may be performed contemporaneously or in a different order than as presented in FIG. 22.

At block 2201, the method 2200 begins.

At block 2210, the domain proxy of a private enterprise network maintains local CBRS GAA channel co-existence policies for the CBSDs supported by the private enterprise network. The local CBRS GAA channel co-existence policies for the CBSDs may specify the optimal non-overlapping/orthogonal CBRS channels for the CBSDs. The non-overlapping/orthogonal CBRS channels for the CBSDs specified in the local CBRS GAA channel co-existence policies for the CBSDs may be based on RF engineering, one or more SON algorithms, or the like, as well as various combinations thereof. For example, optimal non-overlapping/orthogonal CBRS GAA channel lists may be identified for each of the CBSDs via precise RF engineering and/or one or more appropriate SON algorithms and then the local CBRS GAA channel co-existence policies including the optimal non-overlapping/orthogonal CBRS GAA channel lists can be defined for the CBSDs. It will be appreciated that, although primarily presented with respect to use of individualized local CBRS GAA channel co-existence policies for the respective CBSDs, a single local CBRS GAA channel co-existence policy may be formed for the enterprise network where the single local CBRS GAA channel co-existence policy includes the respective optimal non-overlapping/orthogonal CBRS GAA channel lists for the respective CBSDs of the private enterprise network.

At block 2220, the domain proxy handles forwarding of Spectrum_Inquiry( ) messages sent by the CBSDs toward the SAS service inquiring about available CBRS channels for the CBSDs. The domain proxy receives the Spectrum_Inquiry( ) messages from the CBSDs and sends the Spectrum_Inquiry( ) messages toward the SAS service (e.g., toward one or more regional SAS instances or other SAS instances).

At block 2230, the domain proxy intercepts Spectrum_Inquiry_Resp( ) messages sent by the SAS service toward the CBSDs in response to the Spectrum_Inquiry( ) messages of the CBSDs. The Spectrum_Inquiry_Resp( ) message sent to a CBSD may include a list of available CBRS channels that are available for selection by the CBSD to obtain a CBRS channel grant from the serving SAS instance.

At block 2240, the domain proxy modifies one or more Spectrum_Inquiry_Resp( ) messages, based on the CBRS GAA channel co-existence policies for the CBSDs, to form modified Spectrum_Inquiry_Resp( ) messages that are configured to ensure selection of non-overlapping/orthogonal CBRS channels by the CBSDs. The modification of a Spectrum_Inquiry_Resp( ) message for a CBSD to form a modified Spectrum_Inquiry_Resp( ) message for the CBSD may include modification of the list of available CBRS channels that are available for selection by the CBSD. As indicated above, this protects against instances in which the SAS service sends the same set of available CBRS channels to the CBSDs and the CBSDs end up selecting the same CBRS channels to use for CBRS operation.

At block 2250, the domain proxy sends the modified Spectrum_Inquiry_Resp( ) messages toward the CBSDs which sent the Spectrum_Inquiry( ) messages, respectively.

At block 2260, the domain proxy then facilitates CBRS channel request/grant communications between the CBSDs and the SAS service. The CBSDs receive the modified Spectrum_Inquiry_Resp( ) messages, select respective CBRS channels based on the respective available CBRS channel lists in the modified Spectrum_Inquiry_Resp( ) messages, and send CBRS channel requests for the selected CBRS channels toward the SAS service. The domain proxy receives the CBRS channel requests from the CBSDs and forwards the CBRS channel requests toward the SAS service. The SAS service grants CBRS channels to the CBSDs in response to the CBRS channel requests and sends CBRS channel responses, including indications of the CBRS channels granted to the CBSDs, toward the CBSDs. The domain proxy receives the CBRS channel responses and forwards the CBRS channel responses toward the CBSDs.

At block 2299, the method 2200 ends.

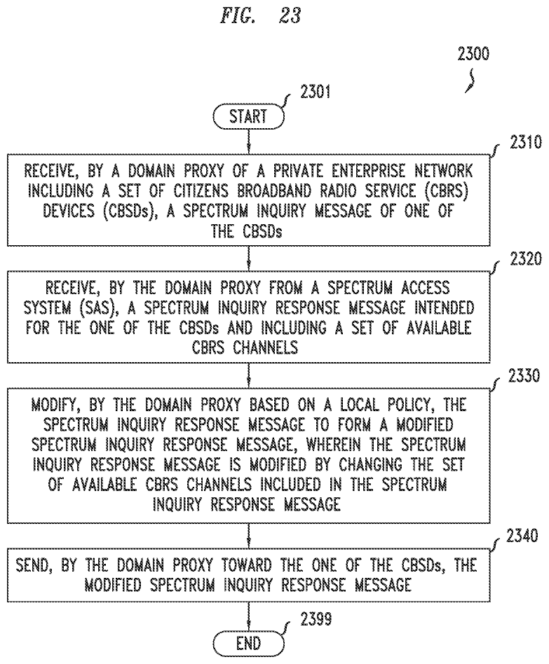

FIG. 23 is a flow diagram of a method of operating a domain proxy to support a local co-existence management policy capability according to some embodiments. It will be appreciated that, although primarily presented herein as being performed serially, at least a portion of the functions of method 2300 may be performed contemporaneously or in a different order than as presented in FIG. 23. At block 2301, the method 2300 begins. At block 2310, receive, by a domain proxy of a private enterprise network including a set of Citizens Broadband radio Service (CBRS) Devices (CBSDs), a spectrum inquiry message of one of the CBSDs. At block 2320, receive, by the domain proxy from a spectrum access system (SAS), a spectrum inquiry response message intended for the one of the CBSDs and including a set of available CBRS channels. At block 2330, modify, by the domain proxy based on a local policy, the spectrum inquiry response message to form a modified spectrum inquiry response message, wherein the spectrum inquiry response message is modified by changing the set of available CBRS channels included in the spectrum inquiry response message. At block 2340, send, by the domain proxy toward the one of the CBSDs, the modified spectrum inquiry response message. At block 2399, the method 2300 ends.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

As used herein, the term “circuitry” may refer to one or more or all of the following:
(a) hardware-only circuit implementations (such as implementations and only analog and/or digital circuitry) and
(b) combinations of hardware circuits and software, such as (as applicable):
   (i) a combination of analog and/or digital hardware circuit(s) with software/firmware and
   (ii) any portions of a hardware processor(s) with software (including digital signal processor(s), software, and memory(ies) that work together to cause an apparatus, such as a mobile phone or server, to perform various functions) and
(c) hardware circuit(s) and/or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular network device, or other computing or network device.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An apparatus, comprising:
at least one processor; and
at least one memory storing instructions which, when executed by the at least one processor, cause the apparatus at least to:
receive, by a domain proxy for a set of spectrum access system (SAS) instances that includes a plurality of regional SAS instances and at least one local SAS instance, SAS load status information that includes, for each of the SAS instances in the set of SAS instances, respective SAS instance load status information for the respective SAS instance; and
control, by the domain proxy based on at least a portion of the SAS load status information, forwarding of Citizens Broadband radio Service Device (CBZ) traffic toward the set of SAS instances.

2. The apparatus of claim 1, wherein, to receive the SAS load status information, the instructions, when executed by the at least one processor, cause the apparatus at least to:
send, by the domain proxy toward each of the SAS instances in the set of SAS instances, a respective status request message intended for the respective SAS instance; and
receive, by the domain proxy from each of the SAS instances in the set of SAS instances, a respective response message for the respective SAS instance that includes the respective SAS instance load status information for the respective SAS instance.

3. The apparatus of claim 1, wherein, for at least one of the SAS instances, the respective SAS instance load status information for the respective SAS instance includes at least one of a processing load on the respective SAS instance or a database access load on the respective SAS instance.

4. The apparatus of claim 1, wherein, to control forwarding of CBSD traffic toward the set of SAS instances, the instructions, when executed by the at least one processor, cause the apparatus at least to:
detect, by the domain proxy based on the respective SAS instance load status information for the respective one of the regional SAS instances, a load condition associated with the respective one of the regional SAS instances; and
redirect, by the domain proxy based on the load condition associated with the respective one of the regional SAS instances, at least a portion of the CBSD traffic away from the respective one of the regional SAS instances.

5. The apparatus of claim 4, wherein the at least a portion of the CBSD traffic is redirected toward at least a second one of the regional SAS instances.

6. The apparatus of claim 4, wherein the at least a portion of the CBSD traffic is redirected toward one or more of the at least one local SAS instance.

7. The apparatus of claim 1, wherein, to control forwarding of CBSD traffic toward the set of SAS instances, the instructions, when executed by the at least one processor, cause the apparatus at least to:
detect, by the domain proxy based on the respective SAS instance load status information for the respective one of the regional SAS instances, that a load condition previously associated with the respective one of the regional SAS instances has cleared; and
redirect, by the domain proxy based on the load condition previously associated with the respective one of the regional SAS instances has clearer, at least a portion of the CBSD traffic away from the at least one local SAS instance and toward the respective one of the regional SAS instances.

8. An apparatus, comprising:
at least one processor; and
at least one memory storing instructions which, when executed by the at least one processor, cause the apparatus at least to:
receive, by a local spectrum access system (SAS) instance from a regional SAS instance, Citizens Broadband radio Service (CBRS) Device (CBSD) information for a set of CBSDs associated with the local SAS instance, wherein the CBSD information includes CBSD state information for the set of CBSDs associated with the local SAS instance and channel grant information for the set of CBSDs associated with the local SAS instance;
receive, by the local SAS instance from the regional SAS instance, an indication of a completion of a Coordinated Periodic Activities Among SASs (CPAS) computation by the regional SAS instance; and
control, by the local SAS instance based on the CBSD information and the indication of the completion of the CPAS computation by the regional SAS instance, CBRS operations for the set of CBSDs associated with the local SAS instance.

9. The apparatus of claim 8, the local SAS instance receives the CBSD information from the regional SAS instance based on a periodic push of the CBSD information by regional SAS instance.

10. The apparatus of claim 8, wherein the local SAS instance receives the CBSD information from the regional SAS instance based on a periodic pull of the CBSD information by the local SAS instance.

11. The apparatus of claim 8, wherein, to control the CBRS operations for the set of CBSDs associated with the local SAS instance, the instructions, when executed by the at least one processor, cause the apparatus at least to:
determine, based on a loss of network connectivity by a private enterprise network hosting the local SAS instance, whether a last data synchronization by the local SAS instance with the regional SAS instance occurred after a successful CPAS computation by the regional SAS instance; and
control, by the local SAS based on whether whether the last data synchronization by the local SAS instance with the regional SAS instance occurred after a successful CPAS computation by the regional SAS instance, the CBRS operations for the set of CBSDs associated with the local SAS instance.

12. The apparatus of claim 11, wherein, to control the CBRS operations for the set of CBSDs associated with the local SAS instance, the instructions, when executed by the at least one processor, cause the apparatus at least to:
suspend, by the local SAS instance based on a determination that the last data synchronization by the local SAS instance with the regional SAS instance did not occur after a successful CPAS computation by the regional SAS instance, CBRS operations in the private enterprise network.

13. The apparatus of claim 11, wherein, to control the CBRS operations for the set of CBSDs associated with the local SAS instance, the instructions, when executed by the at least one processor, cause the apparatus at least to:
support, by the local SAS instance based on a determination that the last data synchronization by the local SAS instance with the regional SAS instance did occur after a successful CPAS computation by the regional SAS instance, CBRS operations in the private enterprise network.

14. The apparatus of claim 13, wherein, to support CBRS operations in the private enterprise network, the instructions, when executed by the at least one processor, cause the apparatus at least to:
determine, by the local SAS instance, whether deployment of the set of CBSDs falls within a dynamic protection area (DPA); and
respond, by the local SAS instance, to CBSD requests using the CBSD information and based on whether deployment of the set of CBSDs falls within a DPA.

15. An apparatus, comprising:
at least one processor; and
at least one memory storing instructions which, when executed by the at least one processor, cause the apparatus at least to:
provide, by a regional spectrum access system (SAS) instance toward a local SAS instance, a set of Citizens Broadband radio Service Device (CBSD) information associated with a set of CBSDs associated with the local SAS instance, wherein the CBSD information includes CBSD state information for the set of CBSDs associated with the local SAS instance and channel grant information for the set of CBSDs associated with the local SAS instance; and
provide, by the regional SAS instance toward the local SAS instance, an indication of a completion of a Coordinated Periodic Activities Among SASs (CPAS) computation by the regional SAS instance.

16. The apparatus of claim 15, wherein the regional SAS instance provides the CBSD information toward the local SAS instance based on a periodic push of the CBSD information by the regional SAS instance.

17. The apparatus of claim 16, wherein the instructions, when executed by the at least one processor, cause the apparatus at least to:
receive, by the regional SAS instance from the local SAS instance, a push registration request in which the local SAS instance requests to register to receive periodic pushes of CBSD information from the regional SAS instance; and
register, by the regional SAS instance based on the push registration request, the local SAS instance to receive periodic pushes of CBSD information from the regional SAS instance.

18. The apparatus of claim 15, wherein the regional SAS instance provides the CBSD information toward the local SAS instance based on a periodic pull of the CBSD information by the local SAS instance.

19. The apparatus of claim 18, wherein the instructions, when executed by the at least one processor, cause the apparatus at least to:
receive, by the regional SAS instance from the local SAS instance, a push registration request in which the local SAS instance requests to register to receive periodic pushes of CBSD information from the regional SAS instance; and
register, by the regional SAS instance based on the push registration request, the local SAS instance to receive periodic pushes of CBSD information from the regional SAS instance.

20. An apparatus, comprising:
at least one processor; and
at least one memory storing instructions which, when executed by the at least one processor, cause the apparatus at least to:
receive, by a domain proxy of a private enterprise network including a set of Citizens Broadband radio Service (CBRS) Devices (CBSDs), a spectrum inquiry message of one of the CBSDs;
receive, by the domain proxy from a spectrum access system (SAS), a spectrum inquiry response message intended for the one of the CBSDs and including a set of available CBRS channels;
modify, by the domain proxy based on a local policy, the spectrum inquiry response message to form a modified spectrum inquiry response message, wherein the spectrum inquiry response message is modified by changing the set of available CBRS channels included in the spectrum inquiry response message; and
send, by the domain proxy toward the one of the CBSDs, the modified spectrum inquiry response message.
